(19) United States
(12) Patent Application Publication
(10) Pub. No.: US 2009/0012823 A1
(43) Pub. Date: Jan. 8, 2009

(54) Configuring Office-Specific Security Parameters Using Office Profiles

(75) Inventors: Denise M. Anderson, New Market, MN (US); Bradley E. Bergner, Burnsville, MN (US); David E. Carroll, Suwanee, GA (US); Lalitha Jayaraman, Chinnai (IN); Rachel M. Nilsson, Minneapolis, MN (US); Sankara Rao Vanapalli, Andhra Pradesh (IN); Donna L. Sundstrom, Prior Lake, MN (US)

Correspondence Address: UNISYS CORPORATION, UNISYS WAY, MAIL STATION: E8-114, BLUE BELL, PA, 19424, US

(73) Assignee: Unisys Corporation

(21) Appl. No.: 12/130,690

(22) Filed: May 30, 2008

Related U.S. Application Data
(60) Provisional application No. 60/932,655, filed on Jun. 1, 2007.

(51) Int. Cl. G06Q 10/00; G06F 17/30

(52) U.S. Cl. 705/5; 707/1; 707/E17.044

(57) ABSTRACT

In general, techniques for configuring blacklist handling via regional profiles of reservation and departure control system (RDCS) are described herein. More specifically, a RDCS is disclosed for use in creating operational profiles. A global profile may be dynamically defined to determine operational aspects of a transportation carrier that are common to all office of that carrier. Office profiles are dynamically defined to determine operational aspects that are specific to that office location. In this manner, the operation of each office may be tailored to the specific location. Moreover, the operational aspects are not “hard-coded”, but instead are readily selectable by an authorized end user. According to one aspect, local management of blacklists is supported by the profiles.

This application claims the benefit of U.S. Provisional Application No. 60/932,655, filed Jun. 1, 2007, the entire contents of which are incorporate herein by reference.

### TECHNICAL FIELD

The invention relates to computing systems and, more particularly, to configuring reservation and departure control computing systems.

### BACKGROUND

Transportation carriers such as airlines, trains, bus companies and the like generally employ some type of reservation and departure control system (RDCS). A RDCS may consist of one or more data processing systems that execute software/firmware to support the business of a given transportation carrier. Such RDCSs are used to book passengers, track baggage, manage departures and arrivals, as well as, perform many other tasks associated with travel reservation and departure.

Many large transportation carriers operate over a large geographic area that may span multiple geographical regions, including multiple states or provinces, multiple countries, or multiple continents. In some instances, a transportation carrier may even offer services that encompass the entire world. As a result, transportation carriers often tailor the operation of the RDCS to account for a number of varying regional operational aspects, such as a local currency, local tax laws, and local restrictions governing security. Moreover, many operational aspects of the RDCS may vary from office to office based on local customs and requirements, and the transportation carrier may customize the RDCS to account for these regional requirements.

Typically, the regional variations that exist from office to office are “hard-coded” into the RDCS. That is, a vendor of the RDCS would, prior to installing the software or RDCS at a particular region, tailor or customize the underlying software code to account for the regional variations of a given location. After customizing the code, the vendor compiles the code to generate software as machine instructions executable by a computer, effectively “hard-coding” or making permanent those regional variations in the software. Consequently, even though a core set of all functions are common from one office to another, each office often executes a different hard-coded version of the RDCS software to support the requirements of that office. Developing and maintaining the versions of the software needed to support the local requirements is expensive, time-consuming, and error-prone, as each change to local requirements require software designers of either the vendor or, in some instances, the transportation carrier to again hard-code those changes, recompile the software, and deploy the software at the particular office.

### SUMMARY

In general, techniques are described for managing a reservation and departure control system (RDCS) such that the system provides office-specific or office-level profiles for dynamically tailoring operation of the RDCS to suit regional operational variations of offices. In addition, the system may manage the RDCS such that the RDCS provides at least one global profile that dynamically sets general or global operational guidelines for the transportation carrier. The global profiles may present a first set of operational parameters that are applicable to the transportation carrier as a whole. The office-specific profiles (“office profiles”) may dynamically refine the first set of operational parameters to specify a second sub-set of operational parameters that take into account the regional variations specific to a particular office. Because the office profiles may be dynamically defined, the office profiles may be quickly changed and adapted to account for changes to the regional operation of each office, unlike conventional hard-coded RDCS.

Moreover, the global operational parameter set defines one or more global security parameters that control how the RDCS handles travel documents that are identified as being associated with irregular activity. For example, the global security parameters may define procedures for handling “blacklisted” documents. Blacklisted documents may include lost or stolen documents, document that are associated with fraud, documents held by travelers on a watch-list, etc. The office profile also defines at least one office-specific security parameter that modifies how the RDCS handles the travel documents in accordance with the global security parameter.

For example, a user may interact with a terminal at a local office to request validation of a travel document. If no office profile is defined for that particular office, the request may be handled by the terminal in accordance with the global profile, which may provide that the terminal forward the request to the RDCS so that the RDCS may compare the information for that travel document against locally-stored information retained within a database of the RDCS. If however an office profile is defined for that particular office, the terminal may instead operate in accordance with the office profile, which may provide that the terminal handle the request by transferring the request and additional information associated with a traveler and/or travel document to a third-party blacklist provider for processing. Thus, the global and office profiles may each define respective security parameters to define how the RDCS processes travel documents identified as being associated with irregular activity, where the office profile may refine the handling or processing of travel documents specified by the global security parameter. As a result, the office profile may tailor handling of travel documents identified as being associated with irregular activity to suit a particular office's regional requirements, such as state or local laws, international procedures, etc.

One or more users may define the global and office profiles through interactions user interfaces presented by a user interface module included within the RDCS. In other words, the RDCS may comprise a mainframe or other computer that includes the user interface module. The user interface module may present a user interface that allows the one or more users to dynamically define the global and office profiles without having to reprogram or otherwise make the changes permanent by hard-coding the regional variations. The computer may also include configuration logic, e.g., a memory comprising instructions, that dynamically configures the terminals of each office in accordance with the global profile and a corresponding office profile. The terminal may then operate as described above to verify security documents. The one or more users may configure the RDCS in this dynamic manner to more easily adapt the RDCS to suit the various regional operations requirements.

In one embodiment, a computer-implemented method for managing a Reservation and Departure Control System (RDCS) of a transportation carrier comprises presenting with a user interface module at least one screen with which one or more users interact to dynamically select first operational parameters of the transportation carrier, wherein the first operational parameters include at least one global security parameter that controls operation of the terminals with respect to handling of travel documents that are identified as associated with irregular activity. The computer-implemented method further comprises storing the first operation parameters to a global profile, and presenting with the user interface module an additional set of one or more screens with which the one or more users interact to dynamically select second operational parameters specific to at least one office of a plurality of offices of the transportation carrier, wherein the second operational parameters include at least one office-specific security parameter that modifies the operation of the one of the terminals in accordance with the at least one global security parameter of the global profile associated with the irregular activity. The computer-implemented method also comprises storing the second office-specific operational parameters to an associated office profile, configuring terminals at each of the plurality of offices of the transportation carrier to operate according to the global profile, and reconfiguring one of the terminals of at least one of the plurality of offices to operate according to the associated office profile.

In another embodiment, a computer-implemented method for managing a Reservation and Departure Control System (RDCS) of a transportation carrier comprises presenting a user interface to allow one or more users to dynamically select operational parameters of the transportation carrier that are stored to a global profile and presenting another user interface to allow the one or more users to dynamically select operational parameters specific to at least one office of the transportation carrier, the parameters specific to the at least one office being stored to an associated office profile. The computer-implemented method further comprising configuring all offices of the transportation carrier to operate according to the global profile and, for each of the at least one office, using the associated office profile to re-configuring the office to operate according to the operational parameters specific to the office, wherein the at least one of the global profile and the associated office profile contain parameters describing blacklisting. The computer-implemented method also comprising operating one of the terminals according to the office-specific security parameter and the security parameter of the global profile such that, in order to blacklist the travel documents, the one of the terminals: (i) receives a request to validate one of the travel documents; (ii) determines, based on the security parameter stored within at least one of the global and the associated office profiles, whether to electronically forward the request to a third party for processing or processes the request locally with the RDCS; and (iii) presents, based on the determination, results of the processing to the user.

In another embodiment, a system for managing a Reservation and Departure Control System (RDCS) of a transportation carrier, comprises a user interface module that presents one or more user interfaces that allow one or more users to dynamically select operational parameters of the transportation carrier that are stored to a global profile and allow the one or more users to dynamically select operational parameters specific to at least one office of the transportation carrier that are stored to an associated office profile, wherein the first operational parameters include at least one global security parameter that controls operation of the terminals with respect to handling of travel documents associated with irregular activity, and wherein the second operational parameters include at least one office-specific security parameter that modifies the operation of the one of the terminals in accordance with the at least one global security parameter of the global profile associated with the irregular activity. The system further comprises configuration logic to configure terminals at all offices of the transportation carrier to operate according to the global profile, and, for each of the at least one office, to use the associated office profile to re-configure the terminals at each of the at least one office to operate according to the operational parameters specific to the at least one office.

In another embodiment, a computer-implemented system for managing a Reservation and Departure Control System (RDCS) of a transportation carrier comprises terminals to access the RDCS and the RDCS. The RDCS includes a computer executing a user interface module that presents one or more user interfaces that allow one or more users to dynamically select operational parameters of the transportation carrier that are stored to a global profile and allow the one or more users to dynamically select operational parameters specific to at least one office of the transportation carrier that are stored to an associated office profile. The first operational parameters include at least one global security parameter that controls operation of the terminals with respect to handling of travel documents associated with irregular activity, and the second operational parameters include at least one office-specific security parameter that modifies the operation of the one of the terminals in accordance with the at least one global security parameter of the global profile associated with the irregular activity. The RDCS further includes configuration logic to configure terminals at all offices of the transportation carrier to operate according to the global profile, and, for each of the at least one office, to use the associated office profile to re-configure the terminals at each of the at least one office to operate according to the operational parameters specific to the at least one office. One of the terminals also receives a request to validate one of the travel documents, determines, based on the at least one global security parameter and the at least one office-specific security parameter, whether to forward the request to a third party for processing or processes the request locally with the RDCS, and presents, based on the determination, a result of the processing to the user.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram of one embodiment of a Reservation and Departure Control System according to the current invention.

FIG. 2 is a block diagram illustrating an exemplary embodiment of the Reservation and Departure Control System of FIG. 1 in further detail.

FIG. 3 is a block diagram of profile definition logic and that illustrates the flow of data between some of the modules of FIG. 2 in a manner that supports one embodiment of the invention.

FIG. 4 is a screen display used to update an existing office profile.

FIG. 5 is a screen display used to update the forms of payment included within an office profile.

FIG. 6 is a screen display used to update the types of currency that are accepted by the office being described in the office profile.

FIG. 7 is a screen display used to update the manner in which sales and refund reports will be handled by the office being described in the office profile.

FIG. 8 is a screen display used to update the manner in which coupons and confirmations will be handled by the office being described in the office profile.

FIG. 9 is a screen display used to update the confirmation text that will be issued to confirm the completion of a transaction, such as a ticket sale.

FIG. 10 is a screen display used to update if/how neutral ticketing will be practiced by the office being described in the office profile.

FIG. 11 is a screen display used to update if/how cash drawers will be created by the office being described in the office profile.

FIG. 12 is a screen display used to control how paper documents will be issued by the office being described in the office profile.

FIG. 13 is a screen display used to control how service charges will be levied by the office being described in the office profile.

FIG. 14 is a screen display used to control how vouchers will be issued by the office being described in the office profile.

FIG. 15 is a block diagram illustrating the user of local black list information according to one aspect of the current invention.

FIG. 16 is a screen display obtained when the “Update Documents” option is selected.

FIG. 17 is a screen display provided when the user selects the “Airline Document Numbers” option.

FIG. 18 is a screen display used to determine how blacklisting will be performed.

FIG. 19 is a screen display used to enter blacklist data into the carrier's local blacklist database according to one aspect of the current invention.

FIG. 20 is a screen display used to select neutral ticketing settings for inclusion in an airline profile.

FIG. 21 is a flow diagram of one method of using profiles according to the current invention.

FIG. 22 is one method of practicing blacklists according to the current invention.

### DETAILED DESCRIPTION

The system and method of the current invention provides a flexible approach to managing local office requirements of a transportation carrier. According to the current invention, office profiles may be defined by authorized end users of a Reservation and Departure Control System (RDCS). These office profiles contain all parameters needed to specify the requirements of a particular office location. Such parameters may defined, for instance, the type of currency that is in use, the other forms of payment that are accepted for services, the types of service charges to be levied by a particular office, the types and amount of taxes to be collected, the way lost and/or stolen tickets will be handled, etc. These office profiles may be overlaid upon a more general profile that governs the way the carrier as a whole operates. Both the office and general profiles are programmable, and are readily customized.

Before considering the invention in more detail, an exemplary RDCS configuration that may be adapted for use with the invention is considered for discussion purposes. The RDCS described herein should be understood to be merely exemplary, and many other types of systems may be used instead.

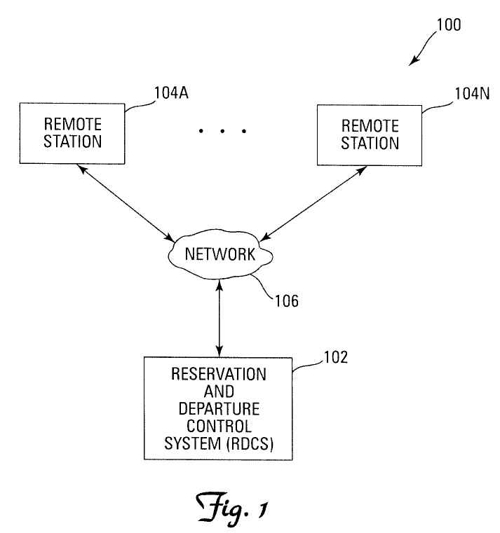

FIG. 1 is a block diagram illustrating an exemplary computing environment 100 in which an RDCS 102 provides management and control functions for a transportation carrier such as an airline. The services provided by RDCS include booking airline flights, issuing tickets, managing the space on flights, determining and managing the routes of the carrier, assigning seats, and so on. According to the invention, the way in which all of these tasks are performed may be customized for the carrier as a whole, as well as on an office-by-office basis using office profiles to be discussed in detail below.

RDCS 102 provides a user interface to allow authorized users residing at remote stations 104A-104N (“remote stations 104”) to perform a number of tasks associated with booking flights. A user may be, for example, front-line staff, a system administrator, a control agent, or any other authorized user. Exemplary tasks include retrieving basic customer data, issuing tickets, checking in customers for departure on the day of travel, retrieving customer contact data, and so on. Remote stations 104 may be associated with a single airline or multiple airlines.

RDCS 102 presents a user interface, which may be a graphical set of interrelated screens (not shown) that allow airline representatives situated at remote stations 104 to initiate booking and check-in activities in preparation for departure. Other airline personnel such as system administrators located at remote stations may utilize user interface screens to enter parameters that are used to govern the manner in which RDCS 102 operates, as will be discussed below.

In one embodiment, each of the users associated with remote stations 104 accesses RDCS 102 via a network 106 using a remote computing device having suitable communication software such as a web browser. Network 106 may be any private or public network, and may include one or more Local Area Networks (LANs), Wide Area Network (WANs), wireless LANs or the like. Network 106 may also include one or more connected network devices (not shown), such as personal computers, laptop computers, handheld computers, workstations, servers, routers, switches, printers, fax machines or other devices.

A user may access RDCS 102 using a network-enabled computing device, such as a workstation, personal computer, laptop computer or a handheld device. The computing device executes the communication software needed to communicate with RDCS 102.

Remote stations 104 may include those located in a single airport or, more likely, in multiple airports. In addition, one or more remote stations 104 may be located outside of the airport environment. For example, one or more remote stations may be located within hotels, travel agencies or other locations. In another example, a user (e.g., a customer) may remotely access RDCS 102 via the Internet from a computing device located within a home or another location. Alternatively, a user may access RDCS 102 via a self-check-in terminal within an airport or other location. In still another embodiment, remote stations may be located at the same facility as RDCS 102.

RDCS 102 may further provide office-specific or office-level profiles for dynamically tailoring operation of RDCS 102 to suit regional operational variations between offices located in different regions. RDCS 102 may also provide at least one global profile that dynamically sets general or global operational guidelines for the transportation carrier. The global profiles may present a first set of operational parameters that are applicable to the transportation carrier as a whole. The office-specific profiles (“office profiles”) may dynamically refine the first set of operational parameters to specify a second sub-set of operational parameters that take into account the regional variations specific to a particular office. Because the office profiles may be dynamically defined, the office profiles may be quickly changed and adapted to account for changes to the regional operation of each office contrary to conventional hard-coded RDCS that require time consuming and often complicated reprogramming to achieve the same result.

As described in more detail below, the global operational parameter set of the global profile may define one or more global security parameters that control how RDCS 102 handles travel documents that are identified as being associated with irregular activity. For example, the global security parameters may define procedures for handling “blacklisted” documents. Blacklisted documents may include lost or stolen documents, document that are associated with fraud, documents held by travelers on a watch-list, etc. Likewise, the office profile may also define at least one office-specific security parameter that modifies how RDCS 102 handles the travel documents in accordance with the global security parameter.

That is, a user may interact with a terminal (not shown in FIG. 1) at a local office, e.g., one of remote stations 104, to request validation of a travel document. If no office profile is defined for that particular office, the request may be handled by the terminal in accordance with the global profile, which may provide that the terminal handle the request by comparing information for that travel document against information retained within a database of RDCS 102. If, however, an office profile is defined for that particular office, the terminal may instead operate in accordance with the office profile, which may provide that the terminal handle the request by transferring the request and additional information associated with a traveler and/or travel document to a third-party blacklist provider for processing. Thus, the global and office profiles may each define respective security parameters to define processing of travel documents identified as being associated with irregular activity, where the office profile may refine the handling or processing of travel documents specified by the global security parameter.

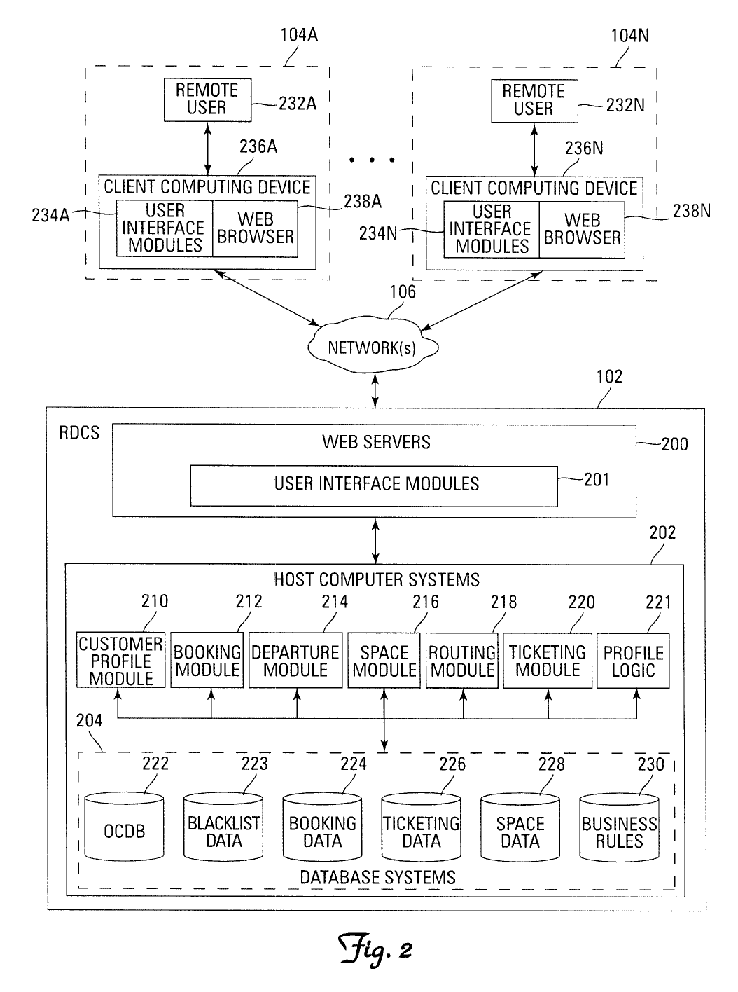

FIG. 2 is a block diagram illustrating an exemplary embodiment of RDCS 102 for hosting management services for one or more airline carriers. In the exemplary embodiment, RDCS 102 includes one or more web servers 200 coupled to host computer systems 202. Host computer systems 202 may include one or more servers executing the UNIX, Linux, Windows®, or any other operating system. Host computer systems 202 provide database systems 204 for storing data. Example database systems include SQL Server™ from Microsoft Corporation and the Oracle™ database from Oracle Corporation. Although illustrated separately, web servers 200 and host computer systems 202 may be integrated as a single system.

Host computer systems 202 provide a computing platform (e.g., processors, memory, storage devices and other components) for executing software service modules 210-221. These service modules generally represent software modules having executable instructions to assist airline personnel in providing airline services. As one example, host computer systems 202 may comprise a computer-readable storage medium, e.g., a memory, comprising instructions, as represented by software service modules 210-221, that a programmable processor executes to perform the techniques described herein. In this example, host computer systems 202 execute a customer profile module 210, a booking module 212, a departure module 214, a space module 216, and a routing module 218, a ticketing module 220. Host computer systems 202 also include profile logic 221, which may be a stand-alone module or may be logic incorporated within one or more of the other modules, such as the ticketing module.

Customer profile module 210 allows a user to create, retrieve, and update customer profile data, which is stored within an Operational Customer Database (OCDB) 222. OCDB 222 provides a centralized repository for maintaining consistent, current customer data for use by any of the service modules 210-220 executed by host computer systems. Customer data may include profiles that describe a customer, and which may include customer contact data, customer preferences such as seating and meal preferences, preferred connection points, hotel and vehicle preferences, frequent flier information, billing and payment information, customer requirements and special requests (e.g., wheelchair requirements, special meal requests, etc.) and so on.

Turning next to booking module 212, this module receives and manages the booking data 224 associated with airline flights. Booking data 224 includes all of the information about a passenger or a group of passengers that are traveling together on the same journey. Such information, sometimes referred to simply as “a booking”, includes passenger names, which one or more flights are included within the trip, and any special requirements such as special meals, wheelchairs, and etc. that may be needed by one or more members in the party. It may further include car rental and hotel information, the manner in which the passengers are being ticketed, data regarding travel documents, contact and payment information, and information regarding any other accommodation or service associated with the journey.

Departure module 214 manages the check-in process on the day of departure, including the check-in of passengers and baggage. For example, an airline employee, shown as one of remote users 232A-232N, may interact with departure module 214 to obtain the issuance of boarding passes and bag tags, and to manage standby passengers. In addition, a remote user may indicate any special needs and requests required by passengers as identified during the check-in process.

Space module 216 manages the space data 228, which is data that describes the space that is available on flights provided by the hosting carrier. For instance, this module controls sales restrictions for flights. This module may be coupled to an external space module (not shown), which provides information on space available on flights provided by other carriers. Another related module, seats module (not shown), provides information on the layout of each aircraft, including information concerning the seating configurations and the assignment of seats.

Routing module 218 utilizes predetermined flight data (not shown in FIG. 2) that describes the flights provided by the airline to determine the various route options that are available to customers. For example, routing module will determine the best way for a customer to travel from a desired departure location to a destination point using the flights hosted by this airline, and/or one or more other airlines.

Ticketing module 220 is used to manage the issuance and handling of travel documents such as tickets. This module verifies appropriate payment forms are received, and generates either an electronic or paper version of a travel document. Ticketing module 220 utilizes and manages ticketing data 226, which includes any electronic travel document images and the templates utilized to create these images. The use of templates is discussed below.

Profile logic 221 may be a stand-alone module, or may be logic that is incorporated into one or more of the other modules, such as the ticketing module 220. This logic allows authorized users such as system administrators to define profiles that control the way in which RDCS 102 functions. Various functional aspects controlled by the profiles include the type of currency that is accepted, the other forms of payment that are accepted, how taxes are calculated, which service charges are to be imposed, and so on. Virtually all selectable attributes of RDCS can be defined using profiles.

In one embodiment, a carrier may define a global profile that governs those aspects of the RDCS that are to be uniform for all of host computer systems 202 hosted by the carrier. In addition, local (or “office”) profiles are defined, each containing those parameters that will vary based on the location of a particular computer system. For instance, an office profile may be defined that contains parameters that are specific to a carrier's Eastern European Office. Another office profile may contain parameters specific to an Asian Office, and so on.

According to one approach, office profiles may be used as follows. Assume RDCS 102 is a distributed system, with host computer systems 202 that are communicatively coupled to one another but located at various offices of the carrier at different locations world-wide. For instance, a first office may be located in North America, another office in Eastern Europe, a third office in Asia, and so on. A global profile may first be loaded on the host computer system of each office to configure the system with parameters that are to be common throughout all offices. For example, such parameters may control how tickets are to be issued, which is to be a common aspect of all systems within all offices. Next, each office may load its own office profile to configure that office with the specific parameters needed for operation in that location, such as the currency that will be accepted in that location.

In another implementation of RDCS 102, the host computer systems 202 are all located in a single location, which may be a world headquarters of the carrier. However, client computer devices 236 that are coupled to RDCS 102 are located in various locations throughout the world. In this case, the global profile is used to configure host computer systems 202, as well as some operational aspects of client computer devices 236. The office profiles are loaded to configure the user interface modules 234 as well as other operation aspects of client computer devices 236 based on the location of those computing devices.

In either of the above-discussed implementations, the result is the same: the data processing capabilities of the office systems are configured to operate according to local requirements without the need to manually configure those systems, e.g., without editing and recompiling the software executed by those office systems. This is discussed further below.

Database 204 is further shown to store blacklist data, which is data describing travel documents that have been “blacklisted.” Such documents may include lost or stolen documents, document that are associated with fraud, documents held by travelers on a watch-list, and so on. This will be discussed further below.

Returning to a more general discussion of host computer systems 202, these systems may include other service modules that are not shown in FIG. 2 because they are beyond the scope of the invention. As examples, an information module may be provided for managing automated information such as visa requirements, luggage policies and procedures, fare rules, promotions and the like. A load control module may be included in the system for assisting airline load control agents in planning the distribution of payload aboard an aircraft. An agreements module may be provided to manage contractual agreements that are maintained between a current carrier and its partners, if any.

The system of FIG. 2 further includes web servers 200, which provide a seamless interface by which remote users 232A-232N or local users (not shown) may access host computer systems 202. Although host computer systems 202 and web servers 200 are illustrated separately in FIG. 2 for exemplary purposes, RDCS 102 may be realized by a single computing device or a plurality of cooperating computing devices located at one or more locations, as discussed above.

According to the exemplary embodiment of FIG. 2, web servers 200 provide a web-based interface by which authorized remote users 232A-232N communicate with RDCS 102 via network 106. In one configuration, web servers 200 execute web server software, such as software marketed by Microsoft Corporation under the trade designation “INTERNET INFORMATION SERVER.” As such, web servers 200 provide an environment for executing user interface modules 201. User interface modules 201 provide an interface that allows users 232A-232N to manage airline reservations, perform check-in functions, and perform the tasks needed to support local processing of quote requests according to the current invention. User interface modules 201 may include Active Server Pages, web pages written in hypertext markup language (HTML) or dynamic HTML, Active X modules, Java scripts, Java Applets, Distributed Component Object Modules (DCOM), and the like.

User interface modules 201 may execute within an operating environment provided by web servers 200. Alternatively, portions of user interface modules 201 may be downloaded as “client-side” user interface modules 234A-234N that are executed on client computing devices 236A-236N, respectively. Client-side user interface modules 234A-234N could, for example, include Active X components or Java scripts executed by web browsers 238A-238N running on client computing devices 236A-236N, respectively.

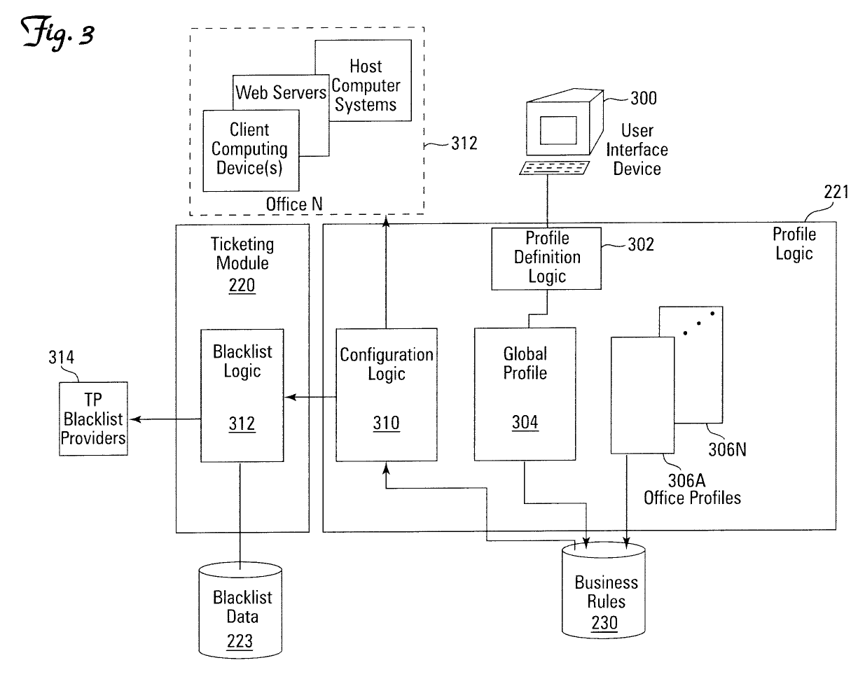

FIG. 3 is a block diagram of profile logic and flow of data between some of the modules of FIG. 2 in a manner that supports one embodiment of the invention. According to one aspect of the invention, when RDCS 202 is first initialized, or at appropriate times thereafter, a system administrator or another authorized airline representative is allowed to tailor business rules 230 to meet the airline's business model. In one embodiment, this is accomplished by utilizing a user interface device 300 such as a personal computer, workstation, a terminal executing a thin client, or some other suitable device to define operational parameters for RDCS. In one embodiment, this user interface device used for this purpose may be one of the remote stations 232 discussed above.

User interface device 300 operates in conjunction with profile definition logic 302 to define the operational parameters for RDCS 102. In one implementation, profile definition logic 302 provides the user interface modules that may be downloaded as user interface modules 201 and/or 234 to support definition of the operational parameters according to the current invention. Exemplary screen displays that are provided by profile definition logic are discussed below.

To begin the definition process, an authorized user gains access to profile definition logic 302, as by supplying an appropriate userid and password. Thereafter, the authorized user is allowed to define the operational parameters that control RDCS 102. These profiles may thereafter be loaded on one or more host computer systems 202, web servers 200, and/or client computing devices 236 to configure these systems, servers, and devices.

In one implementation, at least two different types of profiles may be defined. A global (“airline”) profile 304 may be defined that contains the parameters to configure those aspects of the system that are to be the same at all offices of the carrier. In other words, profile definition logic 302 may present one or more user interface modules by which a user may define global profile 304. The user may for example interact with a series of interrelated screens or windows presented by the one or more user interface modules through input mechanisms, such as buttons, text boxes, scroll boxes, radio buttons, check boxes or any other common input mechanism, to define, edit or otherwise alter global profile 304.

Another set of office profiles 306A-306N may be defined to contain parameters that may be different at the respective offices. For instance, the office profiles may define the types of currency accepted at an office as determined by local practices, the types of taxes that are to be collected according to local laws, the types of security features in use in the office as dictated by local laws, and so on. The types of parameters defined using profile definition logic 302 are discussed in detail below. Again, profile definition logic 302 may present one or more additional user interface modules that comprise a series of interrelated screens or windows. The user may interact with input mechanisms included within these screens or windows to define, edit or otherwise alter office profiles 306A-306N.

After a user has defined one or more office profiles with the aid of profile definition logic 302 and user interface device 300, the user may save these profiles in retentive storage. For instance, these profiles may be saved within business rules 203. Alternatively, the profiles may be saved elsewhere within databases 204, or in another location that may be local or remote to RDCS 102.

In one embodiment, only a single global profile exists within the system at any given time. The parameters contained in that global profile control “common” aspects (that is, those aspects that are common across all offices) of office operation. In a similar manner, this embodiment allows a single office profile to exist at any given time for a particular office. That office profile controls how the office-specific aspects of the corresponding office operation. In this embodiment, when as a global profile is created, the parameters of that profile are retained in the memory of the host computer systems, web servers 200, and/or client computing devices 236 to control how those systems, servers, and/or devices operation. Similarly, when an office profile is created for a given office, that office profile will, by default, be loaded to control how the host computer systems, servers, and/or client computer devices that are specified to that office function.

In another embodiment, multiple global profiles may exist at a given time. Moreover, multiple office profiles may exist for the same office. The profiles that are in use at any given time will be selected by an authorized user. For instance, the user may select one set of profiles for use at high-volume traffic times (e.g., Christmas, spring break, etc.), and may select a different set of profiles to use all other times.

In an embodiment wherein multiple profiles may exist for the same office, and/or for the global profile, configuration logic 310 is employed to select which profile(s) are to be loaded onto each of the computer systems, servers, and computing devices for a given office.

Generally, an authorized user will utilize configuration logic 310 to first select the global profile 304 that is to be used to initialize all of host computer systems 202, web servers 200, and client computer devices 236. Configuration logic 310 (e.g., software instructions executing on a processor) retrieves the selected global profile and loads the parameters contained in the profile onto all of the host computer systems 202 to thereby control programmable aspects of the operation of each of modules 210-220. Configuration logic 310 may also load the parameters of global profile into storage space of web servers 200 to configure one or more of user interface modules 201 and other aspects of the servers. Finally, depending on the types of client computing devices 236 that are in use, configuration logic 310 may further load some of the parameters contained within the profile into storage space of client computing devices 236 to configure one or more user interface modules 234 and other aspects of these devices.

After configuration logic 310 loads the global profiles, the user may further use configuration logic 310 to select an office profile for use in configuring the host computer systems 202, web servers 200, and/or client computing devices 236 that are specific to a particular office. For instance, in FIG. 3, one or more client computing device(s), web server(s), and host computer system(s) may be specific to office N, 312 (shown dashed). Therefore, the parameters contained within the selected office profile for this office will be retrieved from database systems 204 and loaded into the memory and other storage facilities of computer systems 202, web servers 200, and/or client computing devices 236 that are local to this particular office. In this manner, the operational aspects of the office that are to function uniformly across all locations are loaded from the global profile, and the operational aspects that are unique to the location are configured using the corresponding office profile.

Other aspects of the invention are related to blacklist logic 312, which is logic (e.g., executable software instruction on a storage medium) that may reside within ticketing module and determines how blacklisted travel documents will be handled. This logic is configured by settings contained in at least one of the global and the office profiles. According to one embodiment, when a request to validate a travel document is received, that request may be handled locally by comparing information for that travel document against locally-stored information retained within databases 204, and shown as blacklist data 223. Alternatively, or additionally, this request and the associated information may be transferred to a third-party blacklist provider 314 for processing. This will be discussed in detail below.

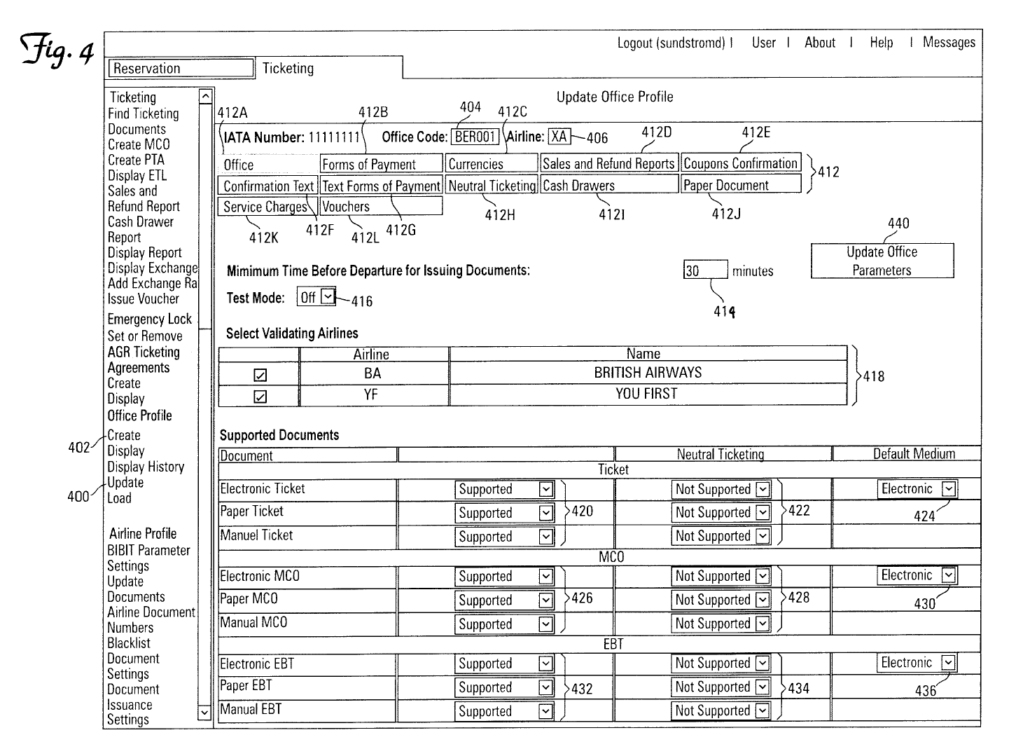

FIG. 4 is a screen display used to update an existing office profile. This screen display, which is obtained using the “Update Office Profile” option 400. When this option is selected, the user is polled for an Office code 404 and an Airline 406. This information uniquely identifies an office profile. When this information is provided by the user, configuration logic 310 retrieves the specified office profile from databases 204 so that the profile may be modified. In particular, the parameters stored within the retrieved profile are used to populate the various screen areas of the update office profile screen, and these parameters may then be updated by the user and stored back to the databases 204. As an example, the screen display of FIG. 4 is obtained when the office profile identified by the Office Code of BER001 and Airline XA is specified by the user.

Once the specified office profile has been retrieved, the various types of parameters included in the profile are available for modification. These parameter types are selected using buttons 412. When the “Office” button 412A is selected, the parameters shown in FIG. 4 are available for update. For instance, these parameters include data that determines how far in advance of departure of a flight documents such as boarding passes will be issued for gaining access to this flight. This time is specified via edit box 414.

Edit box 416 allows a “test mode” to be activated that allows the carrier to test ticket printing. Using test mode, the system may issue a ticket that is not to be used. That ticket may then be voided.

Input areas 418 allow an authorized user to select the airlines that are considered “Validating Airlines” for this office. A validating airline is a third-party airline on whose behalf the airline hosting the RDCS issues tickets. For example, assume that RDCS 102 is the reservation and departure control system for airline XA. That is, airline XA is the airline that “hosts” RDCS 102. Airline XA has contractual agreements with two additional airlines, British Airways and You First Airlines. According to these agreements, XA may issue British Airways tickets or You First tickets using neutral ticket stock. This practice is called “neutral ticketing”. Thus, input area 418 allows each office to select which third-party carrier tickets will be issued by that office. This is important since some third-party carriers may be smaller local carriers, and thus only some offices need issue tickets for those carriers. Moreover, some contractual agreements may indicate that neutralized ticketing will only be practiced in certain geographical regions, which can be readily accommodated by the profiles.

Drop-down menus 420 allow the types of ticket documents that are issued on behalf of the hosting airline to be selected. Ticket types include electronic tickets, paper tickets, and manually-issued tickets. Drop-down menu 422 allow ticket types to be selected for the third-party airlines when neutral ticketing is being practiced in the manner described above. A default ticketing medium may be selected via drop-down menu 424.

In a similar manner, drop-down menus 426 allow the types of Miscellaneous Charge Order (MCO) documents that are issued on behalf of the hosting airline to be selected. MCOs are used to entitle a travel to services that are in addition to transportation services. Such services may include a special meal, an entertainment service (e.g., headphone purchase), use of a wheelchair, access to a special lounge area, and so on. MCO types include electronic tickets, paper tickets, and manually-issued tickets. Similarly, drop-down menus 428 allow MCO types to be selected for the third-party airlines when neutral ticketing is being practiced in the manner described above. A default MCO medium may be selected via drop-down menu 430.

Finally, drop-down menus 432 allow the types of Excess Baggage Tag (EBT) documents that are issued on behalf of the hosting airline to be selected. EBTs are issued when checked baggage exceeds some maximum predetermined weight or dimensions. EBT document types include electronic tickets, paper tickets, and manually-issued tickets. Drop-down menus 434 allow EBT types to be selected for the third-party airlines when neutral ticketing is being practiced in the manner described above. A default EBT medium may be selected via drop-down menu 436.

After an authorized user has finished selecting the office parameters that will govern operation of the office, the user activates the “Update Office Parameters” button 440, which causes the updated selections to be stored to a corresponding office profile 306 within database systems 204.

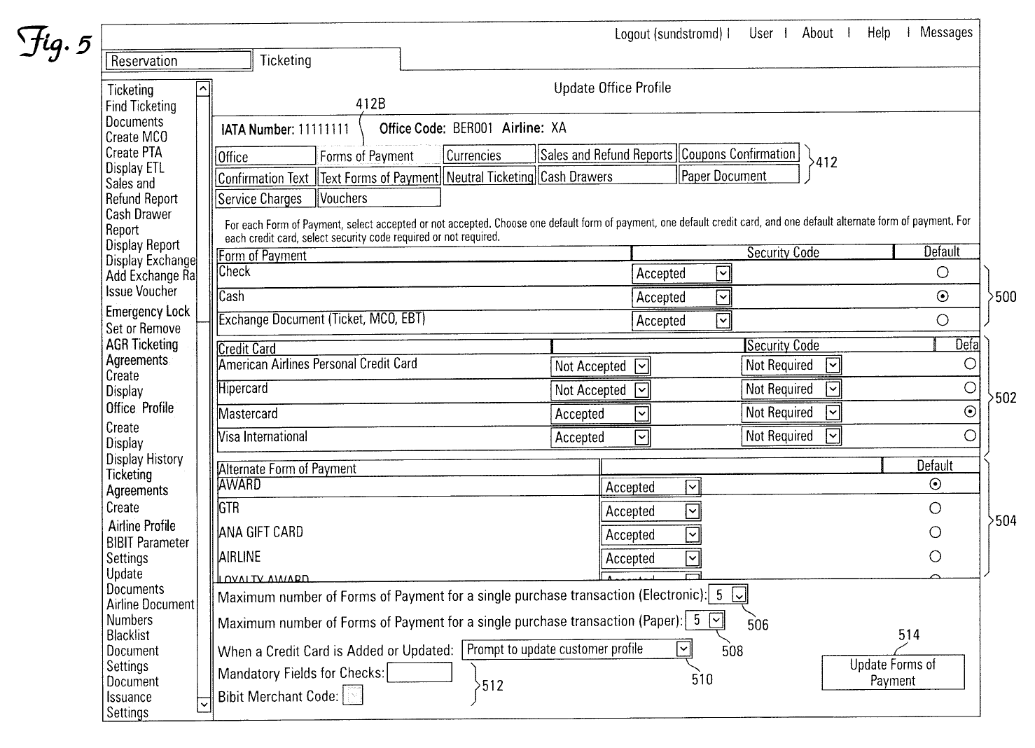

FIG. 5 is a screen display used to update the forms of payment included within an office profile. This screen display is obtained by selecting the “Forms of Payment” button 412B from the Update Office Profile screen display.

Screen area 500 is used to select the allowable forms of payment selected by the office. Such forms include checks, cash, and other exchanged documents such as tickets, MCOs, and EBTs, each of which may be individually accepted or rejected. The user may further indicate which form of payment is the default form of payment.

Screen area 502 is used to determine which credit cards will be accepted by the office, and which of the accepted cards requires use of a security code. Screen area 504 provides allows a user to identify other forms of payment such as frequent flier awards, gift cards, loyalty awards, and so on. A default alternate form of payment may also be selected. Drop-down menu 506 allows a maximum number of payment forms to be specified for a customer making a single purchase of an electronic document. Similarly, drop-down menu 508 allows a maximum number of payment forms to be specified for a single purchase of a paper document.

Drop-down menu 510 allows the office to determine whether, when a customer updates credit card information, that information will be stored to the customer's personal profile within OCDB 222.

Screen area 512 provides an opportunity for an office to indicate which fields an accepted check must include.

When all payment options that will be accepted have been selected, an authorized user activates the “Update Forms of Payment” button 514, which causes the updated selections to be stored to a corresponding office profile 306 within database systems 204.

The screen of FIG. 5 allows an office to customize the types of payment that is accepted by the office. The fields shown in the screen of FIG. 5 are merely exemplary, and the carrier may choose to include other fields in addition, or instead of, those shown in FIG. 5. The fields selected for inclusion are based on the carrier's business model, and may be determined at the time the user interface is defined.

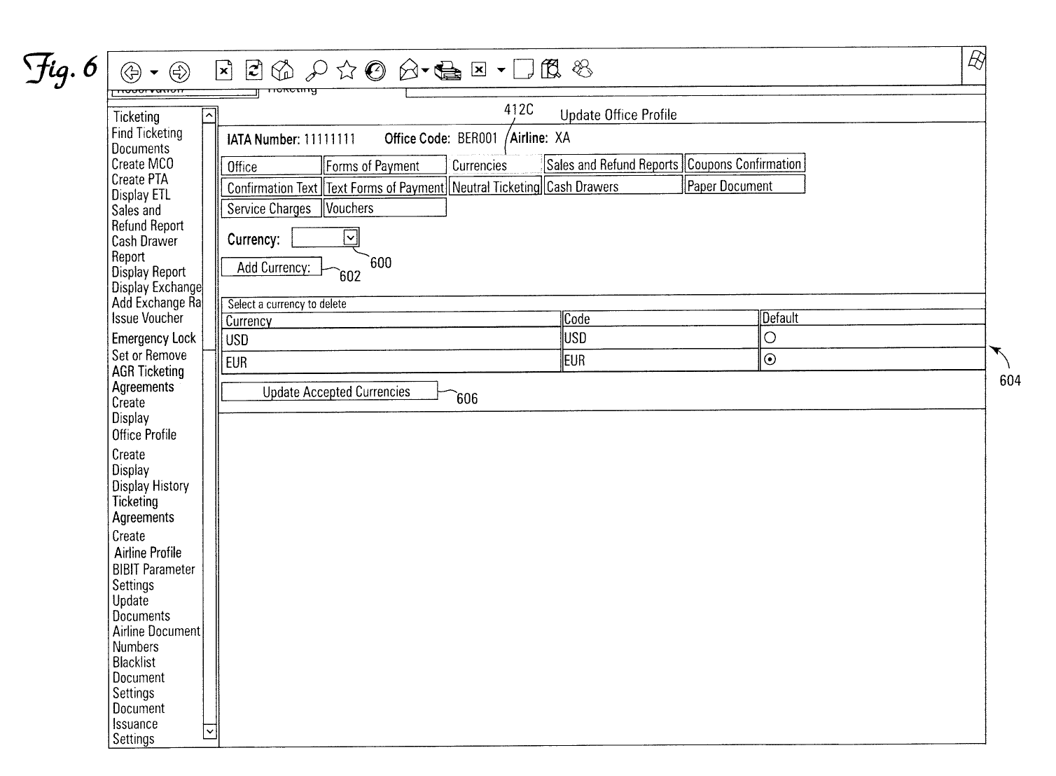

FIG. 6 is a screen display used to update the types of currency that are accepted by the office being described in the office profile. This screen display is obtained by selecting the “Currencies” button 412C from the Update Office Profile screen display.

As may be appreciated, the types of accepted currency will vary based on the office location. An office selects a currency using drop-down menu 600, which will present a list of all currencies that may be accepted by any office anywhere in the world. After a currency is selected from the list, activation of the “Add Currency” button 602 causes this selected current to appear within window 604. This process may be repeated any number of times. In the current example, the currencies that have been accepted included the U.S. Dollar and the Euro.

When all currencies that will be accepted have been selected and appear within window 604, an authorized user activates the “Update Accepted Currencies” button 606, which causes the updated selections to be stored to a corresponding office profile 306 within database systems 204.

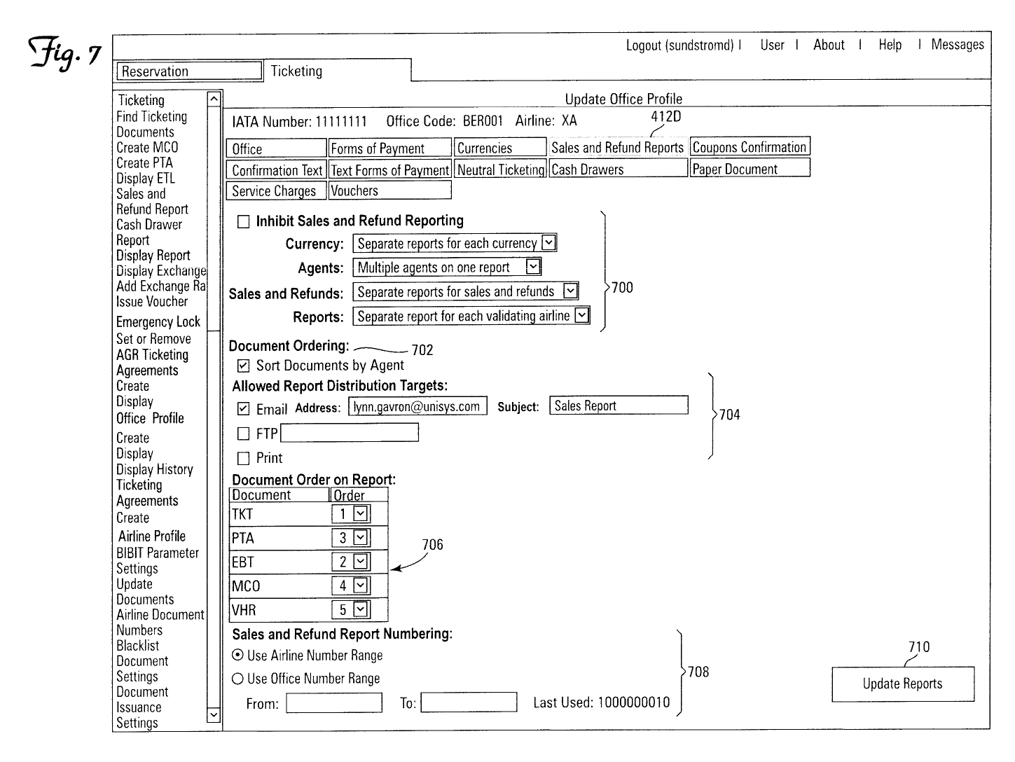

FIG. 7 is a screen display used to update the manner in which sales and refund reports will be handled by the office being described in the office profile. This screen display is obtained by selecting the “Sales and Refund Reports” button 412D from the Update Office Profile screen display.

The selections made using screen area 700 allow an office to tailor how its sales and refund reporting will be performed. For example, separate report may be generated for each type of currency accepted by that office, or a single report may be generated for all currency types. As another example, separate reports may be provided for the sales generated by respective airline agents, or all sales may be reported on the same report. Other selections allow the office to determine whether sales and refunds will be on a single report, and whether each validating carrier will be on a separate report.

Menu item 702 allows an office to determine whether report documents will be sorted by agent. Screen area 704 provides the office with the ability to determine how reports will be distributed by matching email addresses to report types. Other delivery options may be selected including FTP and print options.

Screen area 706 provides an opportunity to select the order in which information will appear on a report. For instance, for sales reports, information will involve ticket sales, prepaid ticket advice (PTA) sales, EBTs, MCOs, and vouchers (VHRs).

Radios and edit boxes 708 allow an office to assign numbers to the reports. The numbers may be selected from a range used by the carrier, or a range specific to that office.

When all report options have been selected, an authorized user activates the “Update Reports” button 710, which causes the updated selections to be stored to a corresponding office profile 306 within database systems 204.

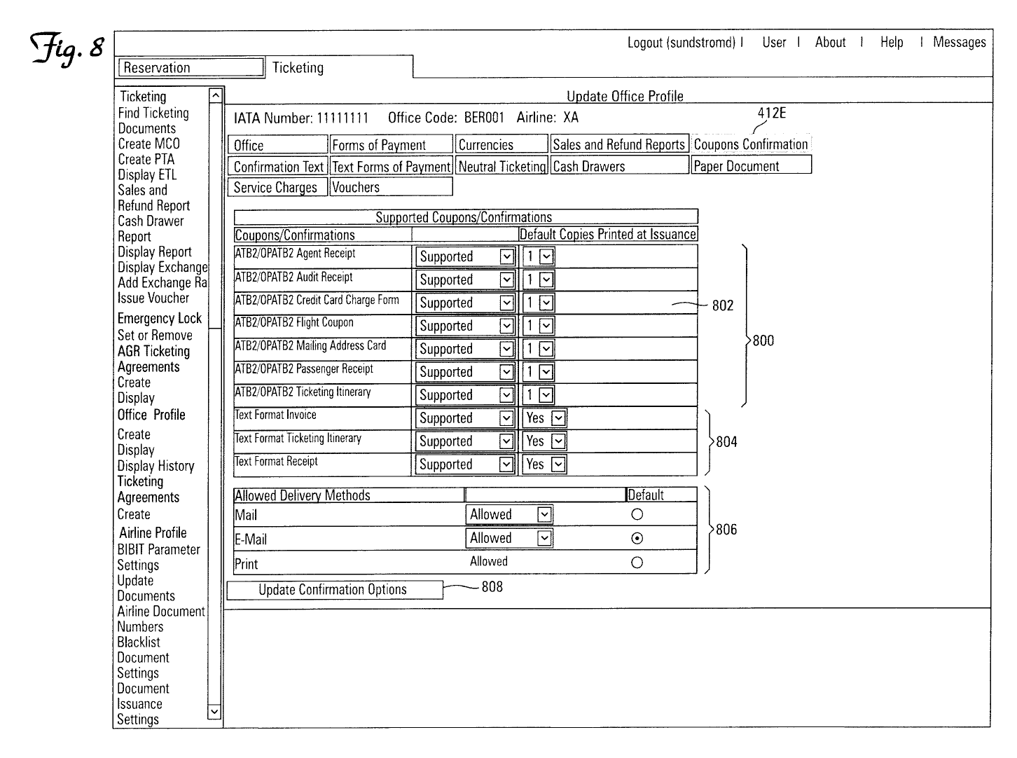

FIG. 8 is a screen display used to update the manner in which coupons and confirmations will be handled by the office being described in the office profile. This screen display is obtained by selecting the “Coupons/Confirmation” button 412E from the Update Office Profile screen display.

Screen area 800 allows an office to determine which types of coupons and confirmations will be supported, as well as the number of copies of each type of document that will be printed at issuance. For example, when a customer charges a service to a credit card, option 802 allows the office to determine whether a credit card charge form will be issued to the customer, as well as how many copies will be printed in total.

Options 804 allow an office to determine whether a text format of certain confirmations is supported. Options 806 allow the office to indicate the forms of delivery options that will be supported for delivery of confirmation. For instance, mail and/or email may be used to deliver a customer's itinerary after that itinerary has been confirmed. Alternatively, or additionally, that itinerary may be sent to a predetermined printer.

The “Update Confirmation Options” button 808 is selected after the report options have been entered to cause the options to be stored to the appropriate office profile 306.

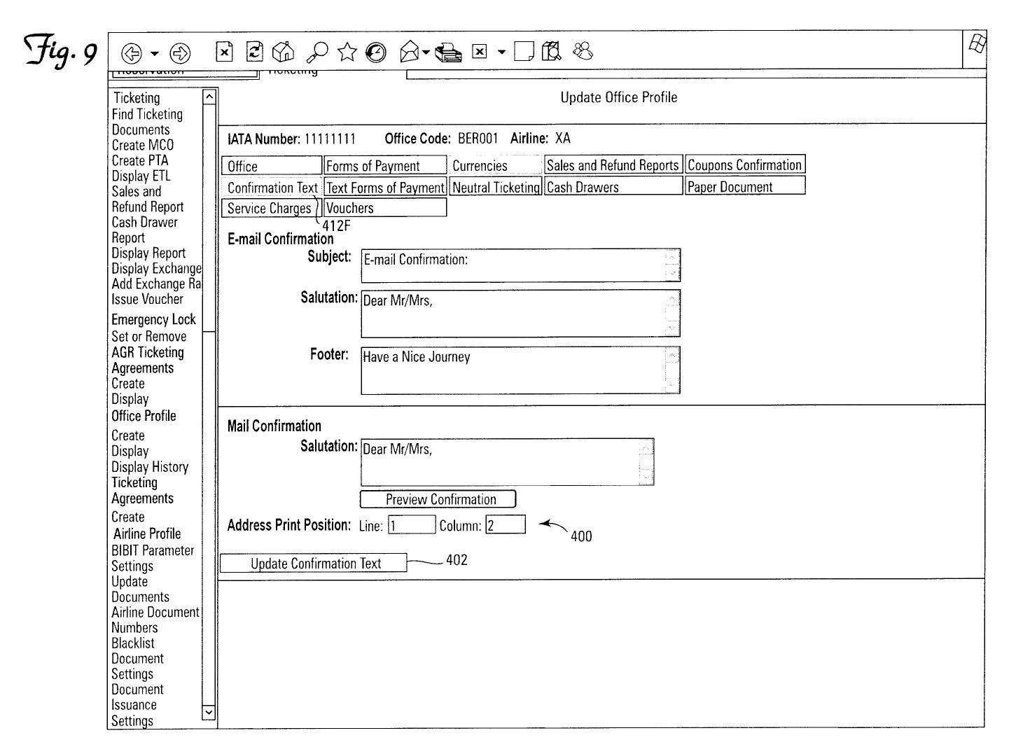

FIG. 9 is a screen display used to update the confirmation text that will be issued to confirm the completion of a transaction, such as a ticket sale. This screen display is obtained by selecting the “Confirmation Text” button 412F from the Update Office Profile screen display. This screen allows an office to determine, for each method of providing customer confirmation (e.g., email, mail, etc.), at least some of the content of that confirmation message, including the salutation and footer. This will be location-specific, based on language and customs of the region in which the office is located. For mail confirmation, the location of the address may be specified using edit boxes 400. The confirmation options are stored to the office profile 306 by selecting the “Update Confirmation Text” button 402.

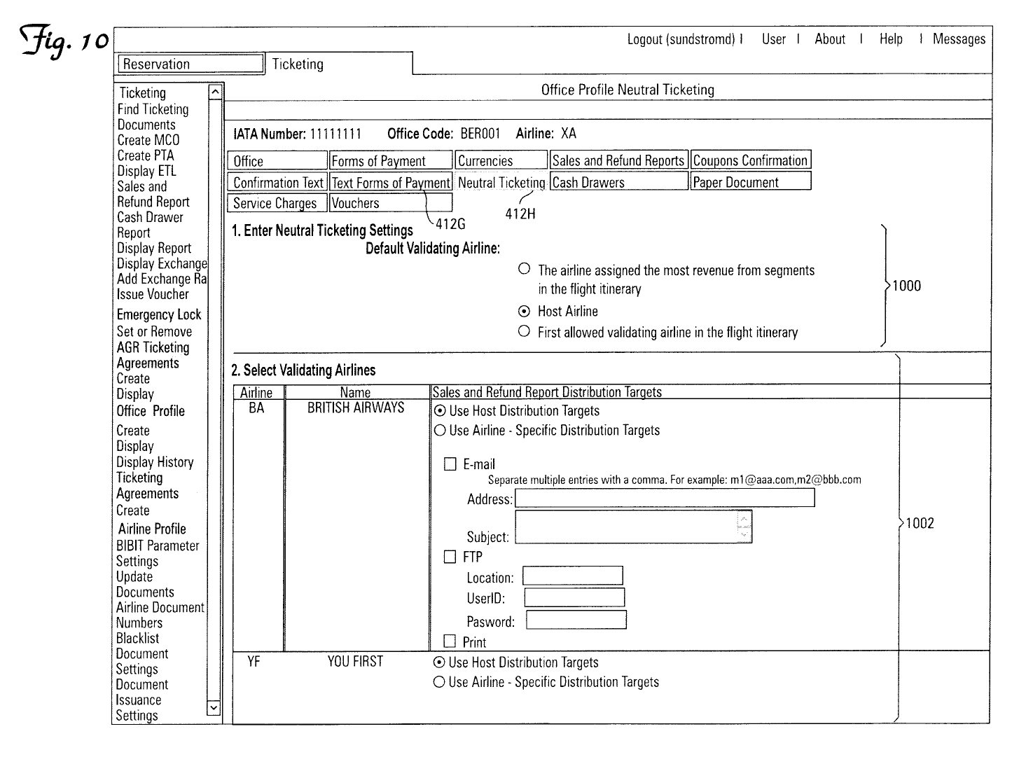

FIG. 10 is a screen display used to update if/how neutral ticketing will be practiced by the office being described in the office profile. This screen display is obtained by selecting the “Neutral Ticketing” button 412H from the Update Office Profile screen display.

As discussed above, neutral ticketing relates to the practice of issuing tickets of another carrier using a neutral ticket stock. When this occurs, one of the airlines involved in the transaction (either the airline that issued the ticket or the airline on which behalf the ticket was issued) will be responsible for validating the ticket at the time the customer checks in for travel. The default validating airline is selected using radios 1000. Screen areas 1002 allow the validating airline to be selected individually for each third-party carrier. In addition, screen areas 1002 indicate how information concerning ticket issuances made on behalf of another carrier is to be communicated to that other carrier (e.g., via email, FTP messaging, messages issued to print devices, etc.)

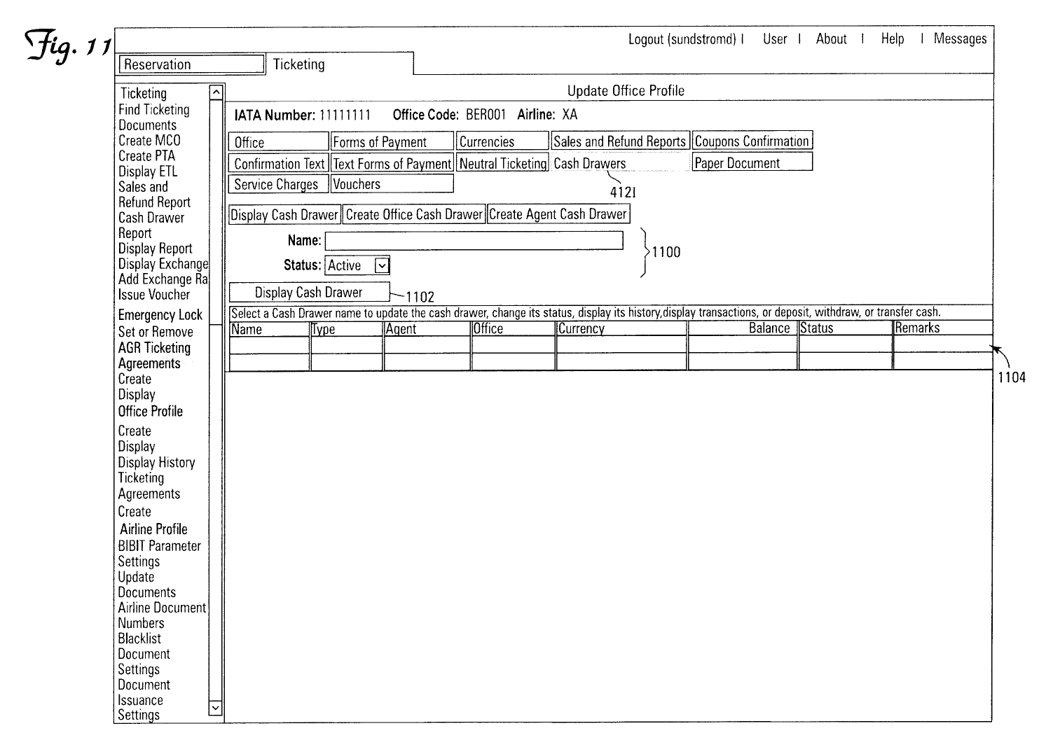

FIG. 11 provides a user with the opportunity to define cash drawers. This screen display is obtained by selecting the “Cash Drawer” button 412I from the Update Office Profile screen display.

A cash drawer is a mechanism for recording incoming and outgoing cash transactions. If an agent receives cash for a ticket sale, that cash is tracked by the cash drawer function. The options of screen area 1100 allow a cache drawer to be assigned a user-selected name and assigned a status of “active” or “inactive”. When the “Display Cash Drawer” button 1102 is selected, the newly-defined cash drawer is displayed in 1102, and is also saved to the office profile 306.

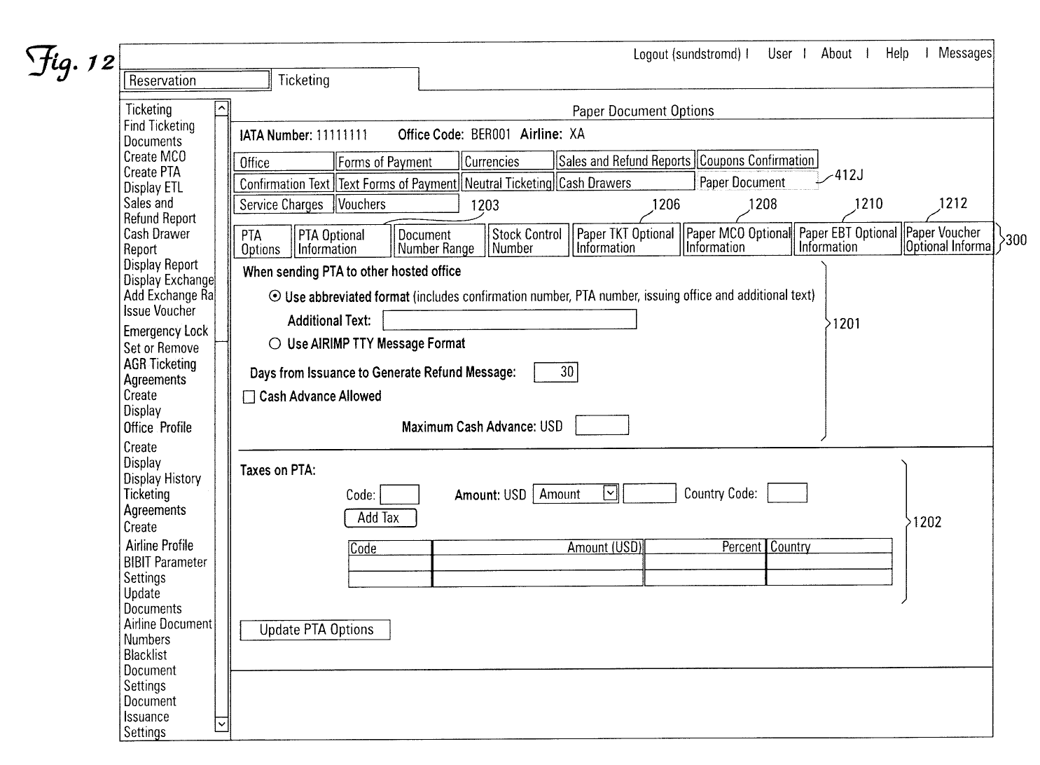

FIG. 12 is a screen display used to control how paper documents will be issued by the office being described in the office profile. This screen display is obtained by selecting the “Paper Document” button 412J from the Update Office Profile screen display.

The screen display of FIG. 12 provides tabs 1200 that may be selected to choose how each type of paper document will be handled. In the example, the “PTA” tab is selected to allow selection of options governing how prepaid ticket advice sales will be handled. This type of sale involves a scenario wherein a customer is prepaying for a ticket on behalf of another party. Screen area 1201 allows the office to control the types of messages that will report this sale, the time period from the sale within which a refund is available, whether a cash advance is allowed for the sale, and if so, what the maximum amount of the advance, and so on.

Screen area 1202 allows the airline to control the amount of any taxes that will be collected on this type of sale, the tax code for the tax, and the country code of the country for which the tax is being collected. Additional options may be selected for PTA sales using tab 1203. The “Update PTA Options” button 1204 is activated to store the PTA options to the office profile 306.

In a manner similar to that described above, the handling of each type of sale involving a paper ticket document may be selected using the options provided on a corresponding screen display selected via one of tabs 1200. For instance, paper ticket operation information is selected via a screen display obtained using tab 1206. The operational information corresponding to sales associated with paper MCOs, EBTs, and vouchers is entered via a display obtained when selecting tabs 1208, 1210, and 1212, respectively. These operational parameters are similar to those shown in FIG. 12 for PTA sales.

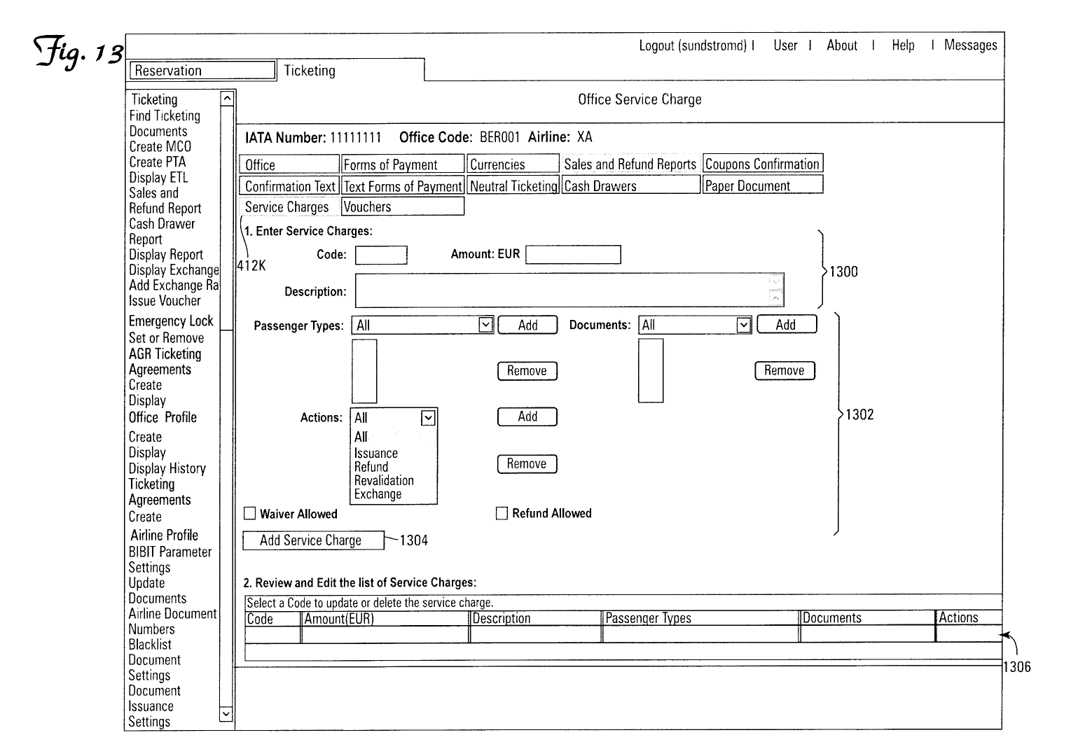

FIG. 13 is a screen display used to control how service charges will be levied by the office being described in the office profile. This screen display is obtained by selecting the “Service Charges” button 412K from the Update Office Profile screen display.

Screen area 1300 allows a code, an amount, and a description to be entered for a corresponding service charge. Screen area 1302 allows the office to specify which types of passengers will be associated with the charges (e.g., only those that are not frequent fliers), the types of actions that will be associated with the charges (e.g., refunds, exchanges, etc.), and what type of documents are associated with the charges (only paper documents, etc.) Thus, for instance, the carrier may define a service charge that may be levied against any customer that is not a frequent flier if that customer is seeking a refund on a ticket that was originally-issued as a paper ticket. Many other types of service charges may be defined in a similar manner using the options shown in FIG. 13. The “Add Service Charge” button 1304 is selected to add the service charge, which then appears within window 1306, and is also stored to the appropriate office profile 306.

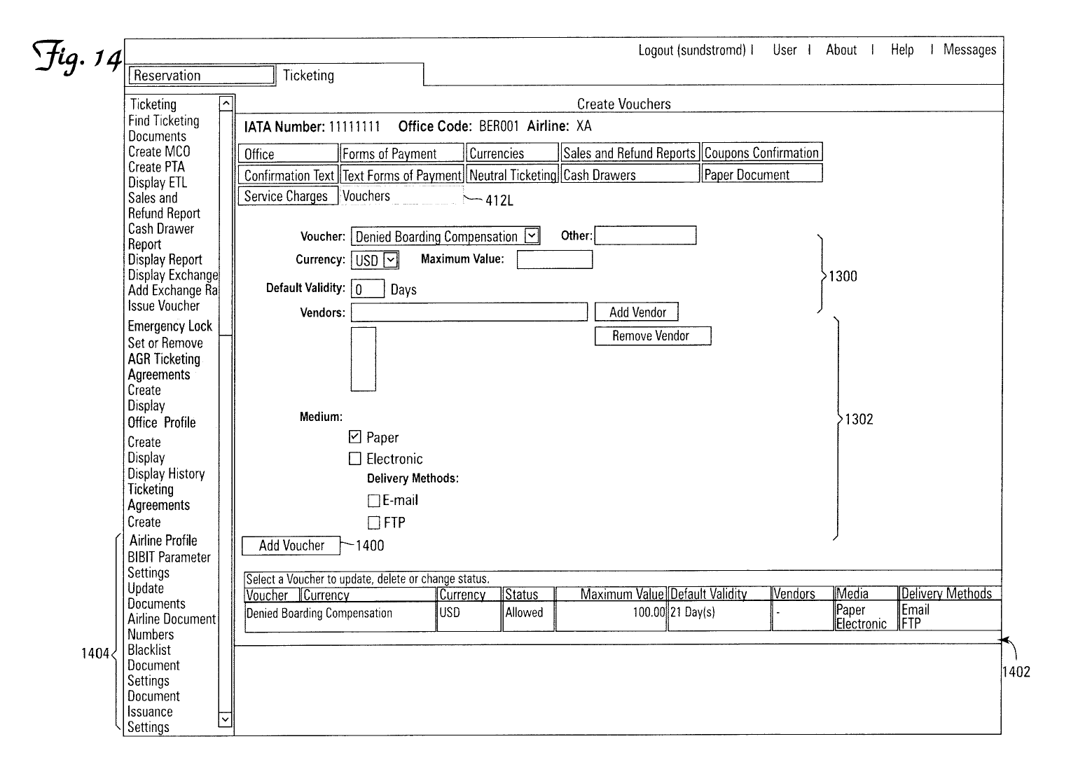

FIG. 14 is a screen display used to control how vouchers will be issued by the office being described in the office profile. This screen display is obtained by selecting the “Vouchers” button 412L from the Update Office Profile screen display. The various options that may be selected include when vouchers will be issued, the amount and type of currency in which the voucher is issued, how long a voucher is valid, the vendor that is issuing the voucher, the medium in which the voucher is delivered (e.g., paper versus electronic), and the delivery method for providing the voucher to the customer. The “Add Voucher” button 1400 is selected to store the definition of the voucher to office profile 306, and to cause that definition to be displayed in Window 1402.

Before continuing, the “Test Forms of Payment” button 412G may be mentioned. Selection of this option provides a screen that allows a user to set up a test form of payment that may be used to test the printing of a ticket. This test form of payment is used in lieu of a real form of payment (e.g., real credit card, etc.) during the testing operation.

In the foregoing manner, virtually any aspect of the operation of an office may be defined using the office profiles. These definitions may be readily supplied by an end-user, such as an office administrator. This eliminates the need to have a software programmer or other technical personnel “re-tool” the interface with hard-coded values for each office location, as was required in the past.

As discussed above, in addition to defining office profiles, the carrier may also define a profile that determines the “common” aspects of office operation. The parameters contained in this global, or “airline”, profile control operational aspects that are common to all of the offices. This type of airline profile may be managed using the “Airline Profile” options 1404 at the left-hand side of the screen.

As shown in FIG. 14, many different types of parameters may be selected for inclusion in an Airline Profile. Examples of these parameters are described in reference to the following Figures.

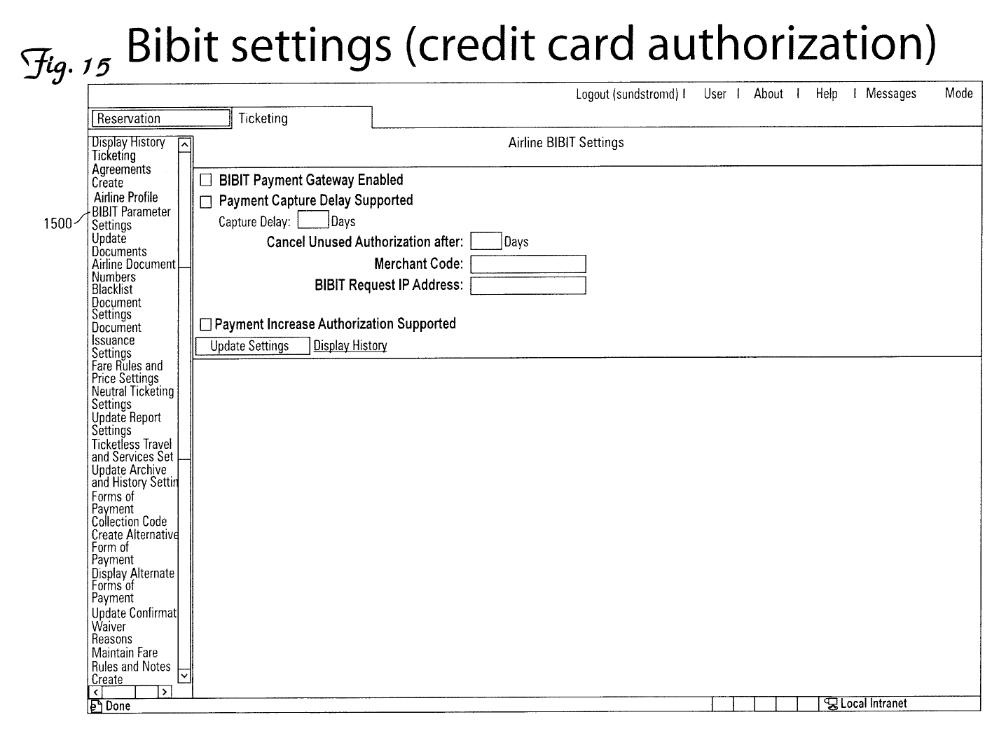

FIG. 15 is a screen display obtained when the “BIBIT Parameter” Airline Profile option 1500 is selected. The selections control how credit card authorization is performed, such as the IP address used to make a BIBIT request to authorize a credit card, the merchant code to be used during this authorization, and how long an unused authorization should be maintained on the system.

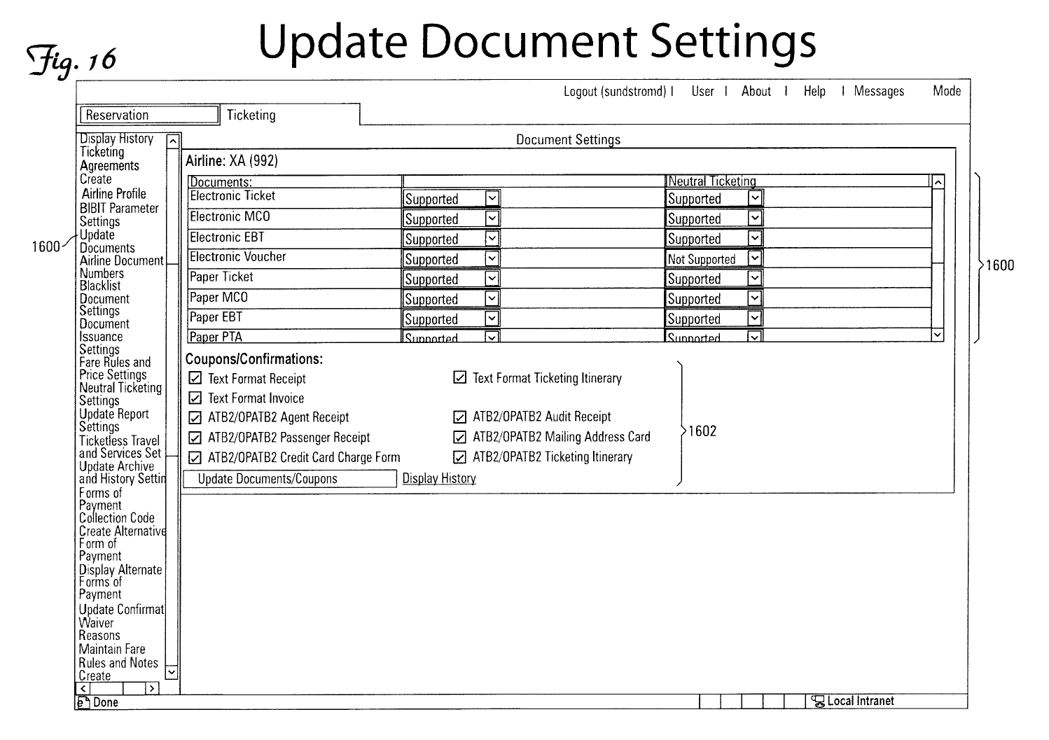

FIG. 16 is a screen display obtained when the “Update Documents” option 1600 is selected. The selections made via this screen display control which types of electronic and paper documents are supported in the system, as well as the types of coupons and confirmations that will be supported by the system.

Several observations may be made by comparing the screen of FIG. 16 which is used to define the Airline profile with the screens of FIGS. 4 and 8 which are used to define the office profiles. As may be appreciated, the selections that are made in screen area 1600 of FIG. 16 are similar to those appear in the “Supported Documents” section of FIG. 4. According to this embodiment, after an authorized utilizes the screen display of FIG. 16 to create an airline profile, the user is allowed to create an office profile. At this time, designated aspects of the Airline profile will be inherited by the office profile by default. As an example, if the user defines all of the document types shown in FIG. 16 to be “Supported”, these document types will be listed as “Supported” by default in a newly-created office profile. The user is then allowed to change these aspects based on the needs of the particular office using the screen display of FIG. 4.

In a similar manner, the coupon/confirmation settings selected via the checkboxes of screen area 1602 of FIG. 16 will be inherited in the Office profile. An authorized user may change these inherited setting via the screen display shown in FIG. 8.

Some settings that are included in the global profile are not to be changed on an office-by-office basis. For these setting, the user is not presented with any opportunity to override the default setting. That is, there is no screen display that allows for modification of these setting when the user is defining the office profile.

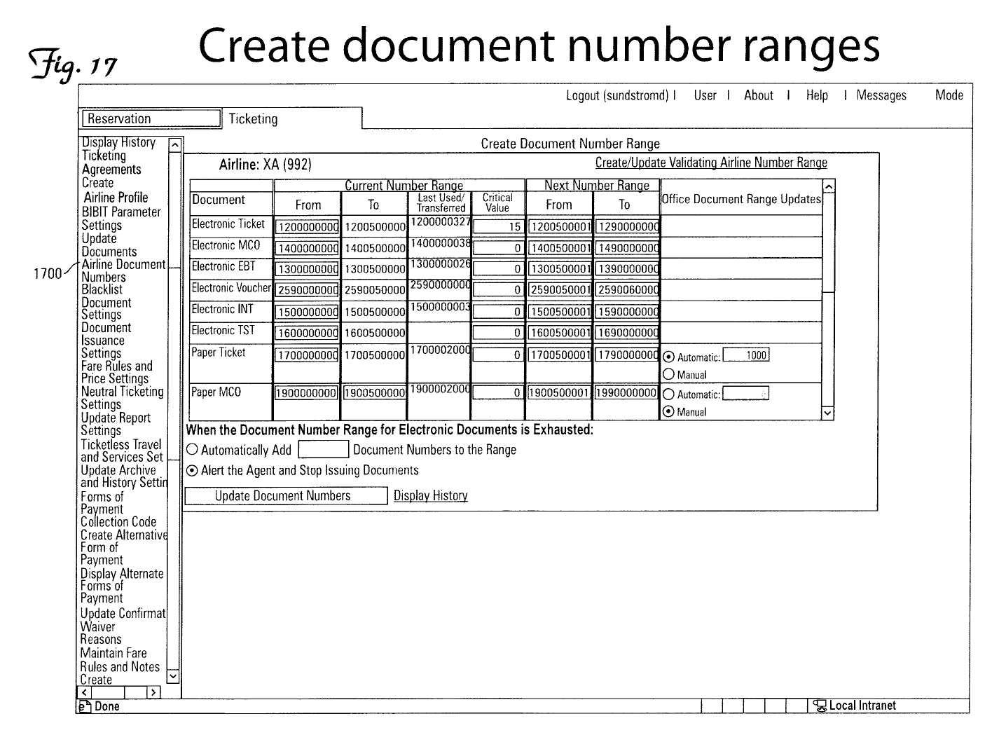

FIG. 17 is a screen display provided when the user selects the “Airline Document Numbers” option. This allows a user to determine the number ranges to be used to issue each of the types of documents shown in FIG. 17. In one embodiment, this is an example of parameters that cannot be overridden at the office level. That is, a user is not allowed to change these setting via any selection available when defining office profiles.

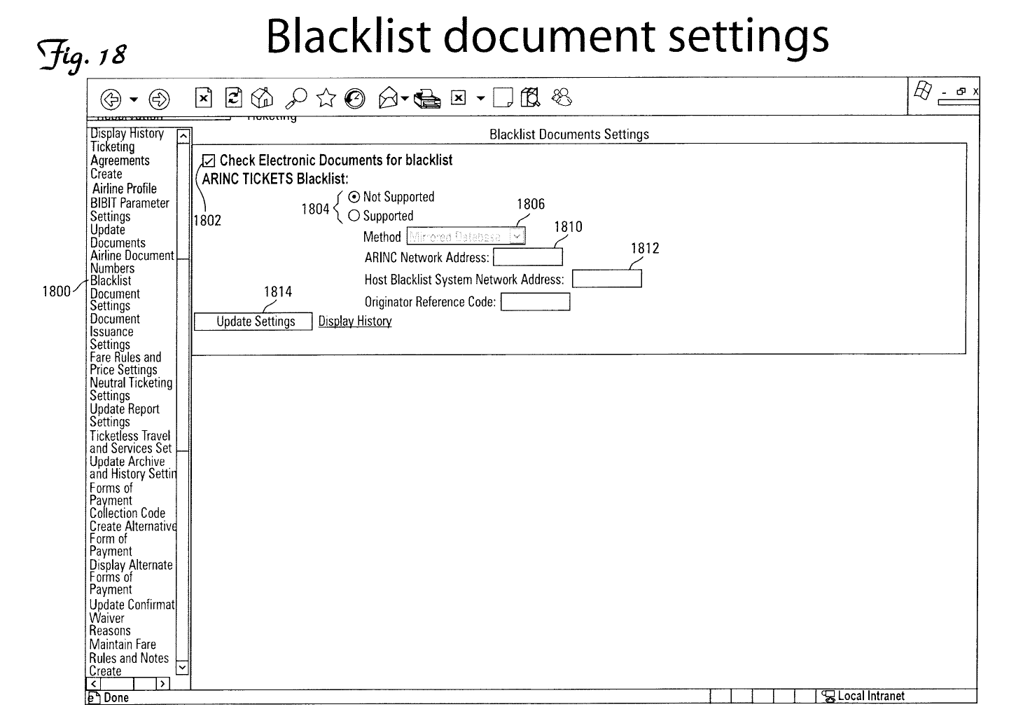

FIG. 18 is a screen display used to determine how blacklisting will be performed. Blacklisting is the practice of specifying documents (e.g., recording the numbers of the documents) that have been lost, stolen, are in the possession of a traveler placed on a watch list by law enforcement or health officials, or in some way associated with some type of irregular activity (e.g., suspected fraud). When a customer attempts to use a document that is listed on a blacklist, the action that will be taken depends on the blacklist status. For instance, the customer may be apprehended by airport security for questioning, or otherwise detained.

Large carriers utilize a third party provider to perform blacklisting functions. For instance, in the airline industry, ARINC Corporation provides blacklisting services to airlines. As such, when a customer is checking in for departure, a request is issued to the third-party provider to determine whether any of the customer's documents have been blacklisted, and if so, how the situation should be handled. The third-party provider consults a blacklist database and returns the appropriate response.

Each such request to a third-party provider for blacklist information incurs a fee. Moreover, this type of mechanism is not flexible, and cannot be altered by the carrier making the request. For example, it may be desirable for the carrier to maintain some, or all, of the blacklist information within local storage so that the request need not be forwarded to the third-party provider for handling. This capability further allows the carrier to add to the blacklist information. For instance, assume that some problem has occurred involving payment for documents. The carrier may wish to add the document numbers to its own internal blacklist so that access to services may be denied until the problem has been resolved.

The screen display of FIG. 18 allows the carrier to determine how blacklisting will be practiced for the airline. For example, checkbox 1802 determines whether electronic documents will be checked against the blacklist (as opposed to tangible documents). Radios 1804 are used to determine whether the third-party blacklisting will be utilized according to conventional methods, or whether blacklisting will solely be practiced locally according to one aspect of the invention.

If third-party blacklisting is utilized, drop-down menu 1806 allows the carrier to determine how the carrier's local blacklist database will be synchronized with the third-party database. For instance, they may be mirrored, such that all documents listed in the local database will mirror those listed in the third-party database. Alternatively, one of the databases may be a predetermined sub-set of the other, or contain different types of entries entirely. In the latter case, both databases must be checked when validating a travel document to determine whether the document was blacklisted. Edit boxes 1810 and 1812 further allows the carrier to specify the network address of the third-party blacklist provider and the address of the host's blacklist system. The blacklist settings are updated in the office profile by selecting the “update Settings” button 1814.

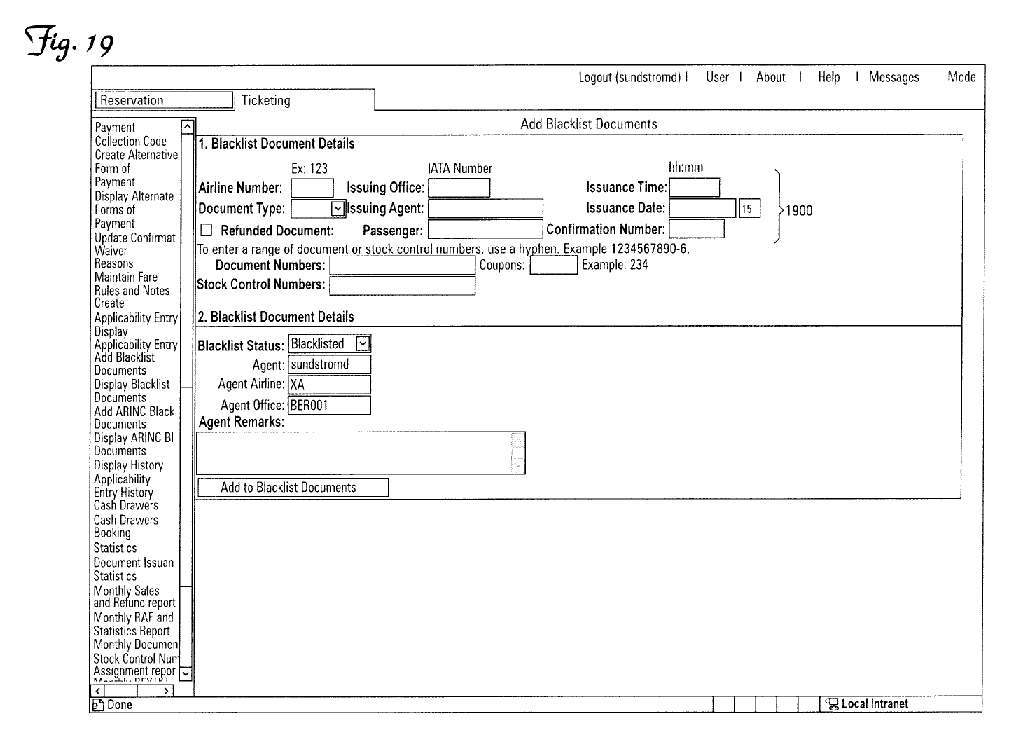

FIG. 19 is a screen display used to enter blacklist data into the carrier's local blacklist database according to one aspect of the current invention. The edit boxes of screen area 1900 are used to enter various attributes concerning the document(s) in question. These attributes include an identifier number that is used to identify the airline that issued the ticket, which is an industry standard designator. Other attributes include the issuing office, the date/time of issuance, the document type (e.g., ticket, MCO, EBT), the issuing agent, the passenger name, and the confirmation number associated with the passenger's itinerary.

The edit boxes of screen area 1902 allow a user to enter one or more document numbers to further identify the documents in question.

Screen area 1904 allows the user to select how the blacklist data is to be reported, including the agent and office that is to receive a report. Additional remarks may be entered, if desired. The “Add to Blacklist Documents” button is activated to add the document(s) to the local blacklist database. In one embodiment, this may also send a request to the third-party provider so that the provider also adds the document(s) to their database. Whether such a request is issued will depend on the parameters selected when using the screen display of FIG. 18 (e.g., whether the databases are to be mirrored.)

In the foregoing manner, the current invention provides a much more flexible approach to blacklisting that is available using conventional RDCSes.

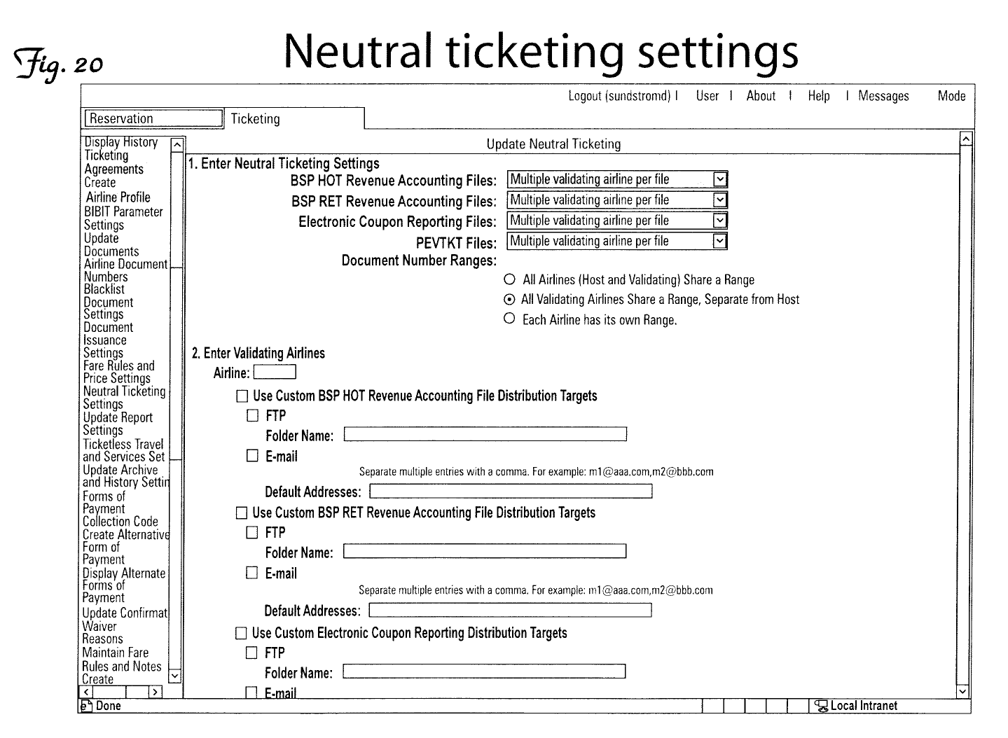

FIG. 20 is a screen display used to select neutral ticketing settings for inclusion in an airline profile. The neutral ticketing settings are entered via the drop-down menus of screen area 2000. The validating airlines are entered using the edit and check boxes of screen area 2002. For instance, the user will enter an airline name in edit box 2004, along with corresponding information for the airline which is entered via the associated checkboxes. This airline name will then populate the screen display for neutral ticketing for the office profiles, as shown in FIG. 10. In other words, in this instance, the selections that become available to the user when defining office profiles are first defined using the airline profile.

In the foregoing manner, many aspects of operation of the RDCS is defined and stored in an office profile. It will be understood that those aspects illustrated in FIGS. 15-20 are merely exemplary, and many other operational setting may be selected instead of, or in addition to, those shown in these Drawings. According to one embodiment, at least some of these aspects are inherited by the office profiles and are then available to be changed in the office profiles. Those aspects that are not visible in the office profiles are not available for change. That is, the offices must operate according to the selections made in the airline profile without exception.

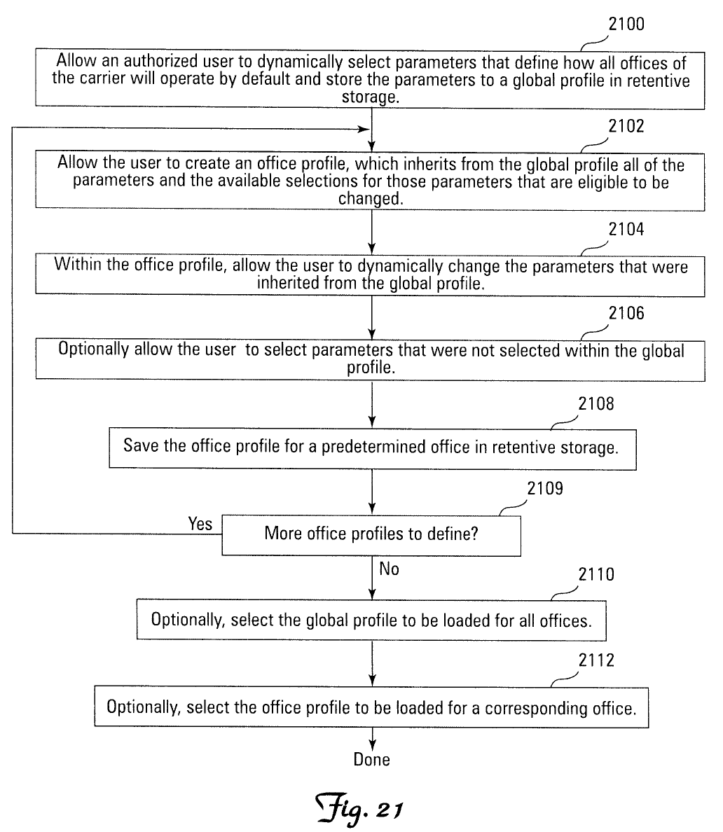

FIG. 21 is a flow diagram of one method of using profiles according to the current invention. First, an authorized user is allowed to dynamically select parameters that define how all offices of a transportation carrier will operate by default (2100). The selection is considered dynamic because it can be accomplished without changing any hardware, software, and/or firmware, and solely through the use of programmable settings and switches. The selected parameters are stored in a global, or “airline,” profile.

Next, the user is allowed to create an office profile, which inherits from the global profile all of the selected parameters from the global profile that are eligible to be changed within the office profile (2102). In one embodiment, all parameters that are not eligible to be changed are not inherited in the office profile.

The user is next allowed to dynamically select the setting for those parameters that were inherited from the global profile (2104). Optionally the user may also be allowed to select some parameters that were not previously defined within the global profile (2106). That is, in one embodiment, some setting must be set at the office level if they are to be used by the office.

The office profile may next be saved to retentive storage in associated with the predetermined office for which it was created (2108). If additional office profiles are to be created, steps 2102-2108 will be repeated, as indicated by decision step 2109.

Next, if multiple global profiles are defined for the system, an authorized user selects one of the profiles to be loaded for all offices of the RDCS (2110). Moreover, if multiple office profiles are defined, the user must further select the office profile to be loaded for each office (2112.)

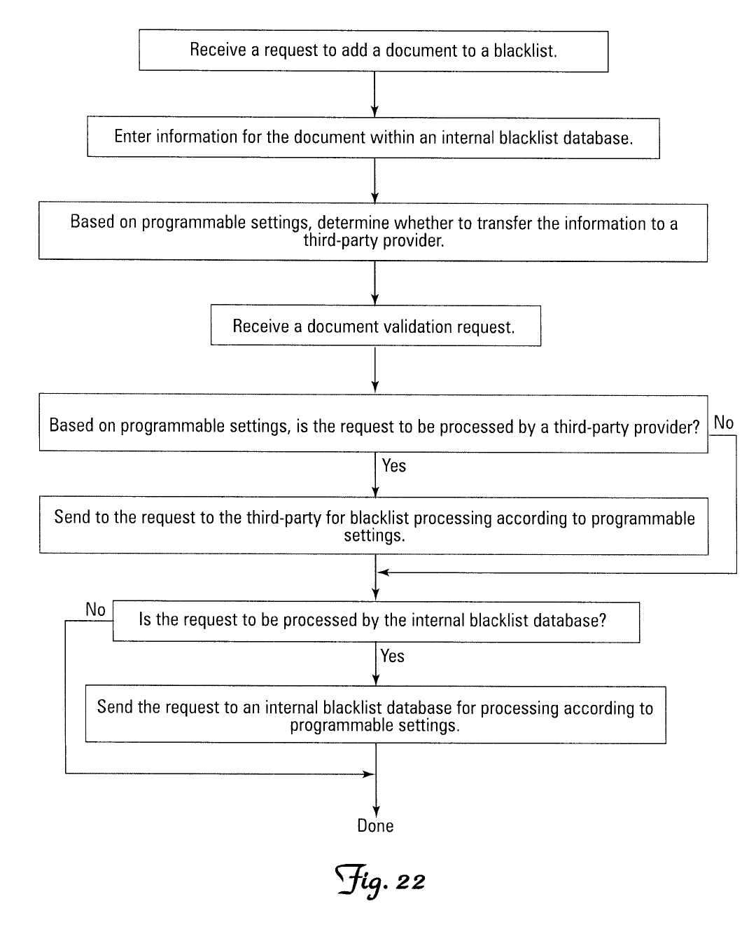

FIG. 22 depicts one example method of practicing blacklists according to the current invention. As shown in FIG. 22, initially blacklist logic, such as blacklist logic 312 of FIG. 3, receives a request to add a document to a blacklist (2200). Blacklist logic 312 may parse the request to determine information for the document and enter the information for the document within an internal blacklist database, such as blacklist database 223 of FIG. 3 (2202). Once entered, blacklist logic 312 may determine, based on dynamically programmable settings, e.g., one or more of at least (i) at least one global profile 304 and (ii) a corresponding one of office profiles 306, whether to transfer the information to a third-party provider, such as third-party blacklist provider 314 (2204).

Subsequently, blacklist logic 312 may receive a document validation request (2206). Based on the programmable settings, blacklist logic 312 may determine whether the request is to be processed by a third-party provider, e.g., third-party blacklist provider 314 (2208). If the programmable settings indicate the third party provider should process the request, blacklist logic 312 sends the request to the third-party provider for blacklist processing in accordance with the programmable settings (2210). If not, however, or in conjunction with sending the request to the third-party provider, blacklist logic 312 may next determine whether the request is to be processed by internal blacklist database 223 (2212).

If the programmable settings indicate that database 223 should process the request, blacklist logic 312 sends the request to internal blacklist database 223 for processing according to the programmable settings (2214). If the programmable settings do not indicate that database 223 should process the request, blacklist logic 312 may be done or finished processing the request and/or wait for another request to add or process a document.

It will be understood that the above-described system and method are susceptible to various modifications and alternative forms. For instance, many variations of the above-described methods are possible. Some of the steps of the foregoing methods may be deleted, and the steps may be re-ordered. These steps may be performed in hardware, software, firmware or any combination thereof.

As noted above, the system and method described herein can be adapted for use by any transportation carrier including, but not limited to, airlines, cruise lines, trains, and bus companies. The above discussion of airline services is provided for illustration purposes only. Therefore, it should be understood that the detailed description is not intended to limit the invention to the particular forms disclosed. On the contrary, the intention is to cover all modifications, equivalents, and alternatives falling within the spirit and scope of the invention as defined by the appended claims.

Various embodiments of the invention have been described. These and other embodiments are within the scope of the following claims.

1. A computer-implemented method for managing a Reservation and Departure Control System (RDCS) of a transportation carrier, comprising:
presenting with a user interface module at least one screen with which one or more users interact to dynamically select first operational parameters of the transportation carrier, wherein the first operational parameters include at least one global security parameter that controls operation of the terminals with respect to handling of travel documents that are identified as associated with irregular activity;
storing the first operation parameters to a global profile;
presenting with the user interface module an additional set of one or more screens with which the one or more users interact to dynamically select second operational parameters specific to at least one office of a plurality of offices of the transportation carrier, wherein the second operational parameters include at least one office-specific security parameter that modifies the operation of the one of the terminals in accordance with the at least one global security parameter of the global profile associated with the irregular activity;
storing the second office-specific operational parameters to an associated office profile;
configuring terminals at each of the plurality of offices of the transportation carrier to operate according to the global profile; and
reconfiguring one of the terminals of at least one of the plurality of offices to operate according to the associated office profile.

2. The method of claim 1 wherein the at least one of security parameter of the global profile and the office-specific security parameter determine procedures used to blacklist the travel documents associated with the irregular activity.

3. The method of claim 1, further comprising operating one of the reconfigured terminals according to the office-specific security parameter and the global security parameter such that, in order to blacklist the travel documents, the one of the reconfigured terminals:
receives a request to validate one of the travel documents;
determines, based on one or more of (i) the at least one global security parameter, and (ii) the at least one office-specific security parameter, whether to electronically forward the request to a third party for processing or processes the request locally with the RDCS; and
presents, based on the determination, a result of the processing to the user.

4. The method of claim 3,
wherein one or more of (i) the at least one global security parameter, and (ii) the at least one office-specific security parameter indicate electronic forwarding of the request to the third party, and
the method further comprising forwarding the request to the third party for processing.

5. The method of claim 3,
wherein one or more of (i) the at least one global security parameter, and (ii) the at least one office-specific security parameter indicate processing the request with the RDCS,
the method further comprising:
maintaining blacklisted information within a local blacklist database so that the request need not be forwarded to the third party for processing; and
processing the request with the RDCS by accessing the blacklist database to determine whether the travel documents are blacklisted.

6. The method of claim 5, wherein maintaining the blacklisted information comprises adding information concerning the travel documents to the blacklisted information.

7. The method of claim 1,
wherein one or more of: (i) the at least one global security parameter, and (ii) the at least one office-specific security parameter indicates how a local blacklist database maintained by the RDCS is synchronized with a third-party database, and
the method further comprising synchronizing the local blacklist database with a third party database in accordance with one or more of the at least one global security parameter and the at least one office-specific security parameter.

8. The method of claim 7, wherein synchronizing the local blacklist database comprises one or more of mirroring all documents listed in the local blacklist database to the third party database and mirroring at least some of the documents listed the third party database to the local blacklist database.

9. The method of claim 1,
wherein one or more of the (i) at least one global security parameter, (ii) and the at least one office-specific security parameter indicates how the RDCS processes requests to validate one of the travel documents, and
the method further comprising processing a request, with the one of the reconfigured terminals, to validate one of the travel documents by checking both a local blacklist database and a third party database to determine whether the one of the travel documents was blacklisted.

10. A computer-implemented method for managing a Reservation and Departure Control System (RDCS) of a transportation carrier, comprising:
presenting a user interface to allow one or more users to dynamically select operational parameters of the transportation carrier that are stored to a global profile;
presenting another user interface to allow the one or more users to dynamically select operational parameters specific to the at least one office of the transportation carrier, the parameters being stored to an associated office profile;
configuring all offices of the transportation carrier to operate according to the global profile;
for each of the at least one office, using the associated office profile to re-configuring the office to operate according to the operational parameters specific to the office, wherein the at least one of the global profile and the associated office profile contain parameters describing blacklisting; and
operating one of the terminals according to the office-specific security parameter and the security parameter of the global profile such that, in order to blacklist the travel documents, the one of the terminals:
(i) receives a request to validate one of the travel documents;
(ii) determines, based on the security parameter stored within at least one of the global and the associated office profiles, whether to electronically forward the request to a third party for processing or processes the request locally with the RDCS; and
(iii) presents, based on the determination, results of the processing to the user.

11. The method of claim 10,
wherein one or more of (i) the at least one global security parameter, and (ii) the at least one office-specific security parameter indicate forwarding the request to the third party;
the method further comprising: electronically forwarding the request to the third party for processing; and
receiving the results form the third party.

12. The method of claim 10,
wherein one or more of (i) the at least one global security parameter, and (ii) the at least one office-specific security parameter indicate processing the request with the RDCS,
the method further comprising:
maintaining blacklisted information within a local blacklist database so that the request need not be forwarded to the third party for processing; and
processing the request with the RDCS by accessing the blacklist database to determine whether the travel documents are blacklisted.

13. A system for managing a Reservation and Departure Control System (RDCS) of a transportation carrier, comprising:
a user interface module that presents one or more user interfaces that allow one or more users to dynamically select operational parameters of the transportation carrier that are stored to a global profile and allow the one or more users to dynamically select operational parameters specific to at least one office of the transportation carrier that are stored to an associated office profile,
wherein the first operational parameters include at least one global security parameter that controls operation of the terminals with respect to handling of travel documents associated with irregular activity, and
wherein the second operational parameters include at least one office-specific security parameter that modifies the operation of the one of the terminals in accordance with the at least one global security parameter of the global profile associated with the irregular activity; and
configuration logic to configure terminals at all offices of the transportation carrier to operate according to the global profile, and, for each of the at least one office, to use the associated office profile to re-configure the terminals at each of the at least one office to operate according to the operational parameters specific to the at least one office.

14. The system of claim 13, further including blacklist processing logic to determine whether a request for validating a document should be processed internal to the RDCS or instead be provided to a third-party for processing base on one or more of the at least one of the global security parameters and the at least one office-specific security parameter.

15. The system of claim 14, further including a storage facility to store programmable settings that are used to control the blacklist logic.

16. The system of claim 13, wherein the configuration logic configures one of the terminals according to the global security parameter and re-configures the one of the terminals according to the office specific security parameter such that, in order to blacklist travel documents, the one of the terminals:
receives a request to validate one of the travel documents;
determines, based on the at least one global security parameter and the at least one office-specific security parameter, whether to forward the request to a third party for processing or processes the request locally with the RDCS; and
presents, based on the determination, a result of the processing to the user.

17. The system of claim 16,
wherein one or more of (i) the at least one global security parameter, and (ii) the at least one office-specific security parameter indicate processing the request with the RDCS,
the system further comprising blacklist processing logic that maintains blacklisted information within a local blacklist database so that the request need not be forwarded to the third party for processing and processes the request by accessing the blacklist database to determine whether the travel documents are blacklisted.

18. The system of claim 17, wherein the blacklist processing logic maintains the blacklisted information by adding information concerning the travel documents to the blacklisted information.

19. The system of claim 13,
further comprising blacklist processing logic,
wherein one or more of (i) the at least one global security parameter, and (ii) the at least one office-specific security parameter indicates how a local blacklist database maintained by the blacklist processing logic is synchronized with a third-party database, and
wherein the blacklist processing logic synchronizes the local blacklist database with a third party database in accordance with the at least one global security parameter and the at least one office-specific security parameter.

20. The system of claim 19, wherein the blacklist processing logic synchronizes the local blacklist database by one or more of mirroring all documents listed in the local blacklist database to the third party database and mirroring at least some of the documents listed the third party database to the local blacklist database.

21. The system of claim 13,
wherein one or more of (i) the at least one global security parameter, and (ii) the at least one office-specific security parameter indicates how the RDCS processes requests to validate a travel document, and
the system further comprising blacklist processing logic that processes a request to validate one of the travel documents by checking both a local blacklist database and a third party database to determine whether the travel document was blacklisted.

22. A computer-implemented system for managing a Reservation and Departure Control System (RDCS) of a transportation carrier, comprising:
terminals to access the RDCS; and
the RDCS that includes:
a computer executing a user interface module that presents one or more user interfaces that allow one or more users to dynamically select operational parameters of the transportation carrier that are stored to a global profile and allow the one or more users to dynamically select operational parameters specific to at least one office of the transportation carrier that are stored to an associated office profile,
wherein the first operational parameters include at least one global security parameter that controls operation of the terminals with respect to handling of travel documents associated with irregular activity, and
wherein the second operational parameters include at least one office-specific security parameter that modifies the operation of the one of the terminals in accordance with the at least one global security parameter of the global profile associated with the irregular activity; and
configuration logic to configure terminals at all offices of the transportation carrier to operate according to the global profile, and, for each of the at least one office, to use the associated office profile to re-configure the terminals at each of the at least one office to operate according to the operational parameters specific to the at least one office,
wherein one of the terminals receives a request to validate one of the travel documents, determines, based on the at least one global security parameter and the at least one office-specific security parameter, whether to forward the request to a third party for processing or processes the request locally with the RDCS, and presents, based on the determination, a result of the processing to the user.

23. The system of claim 22,
wherein one or more of (i) the at least one global security parameter, and (ii) the at least one office-specific security parameter indicate forwarding the request to the third party,
the RDCS further comprising blacklist processing logic to forward the request to the third party for processing and receive the results from the third party.

24. The system of claim 22,
wherein one or more of (i) the at least one global security parameter, and (ii) the at least one office-specific security parameter indicate processing the request with the RDCS,
the RDCS further comprising blacklist processing logic that maintains blacklisted information within a local blacklist database so that the request need not be forwarded to the third party for processing and processes the request with the RDCS by accessing the blacklist database to determine whether the travel documents are blacklisted.
